(19) United States
(12) Patent Application Publication
(10) Pub. No.: US 2026/0195545 A1
(43) Pub. Date: Jul. 9, 2026

(54) SYSTEMS, METHODS, AND APPARATUSES FOR OPTIMIZING DISTRIBUTED NATURAL LANGUAGE PROMPTS USING MUTABLE TEMPLATES

(71) Applicant: Beyond AGI LLC, Austin, TX (US)

(72) Inventors: Pavel Jacko, Westbeemster (NL); Marko Lehtimäki, Hyllykallio (FI); Harri S. Sarsa, Berlin (DE)

(21) Appl. No.: 19/438,664

(22) Filed: Jan. 2, 2026

Related U.S. Application Data
(60) Provisional application No. 63/741,523, filed on Jan. 3, 2025.

(51) Int. Cl. G06F 40/40; G06F 40/186; G06F 40/197; G06F 40/284; G06F 40/30; G06N 3/086

(52) U.S. Cl. CPC G06F 40/40; G06F 40/186; G06F 40/197; G06N 3/086; G06F 40/284; G06F 40/30

(57) ABSTRACT

The present disclosure sets forth systems, apparatuses, and methods for optimizing natural language prompt templates across distributed networks of computational nodes. Neurons may comprise a two-layer architecture: a static layer containing predetermined behavioral schemas (neuron DNA) that establish roles and constraints, and a dynamic layer containing mutable prompt templates that evolve within those constraints. Neurons may further comprise an elasticity characteristic ranging from zero to a maximum value that determines propensity for mutation—neurons with zero elasticity never mutate regardless of environmental feedback, while highly elastic neurons mutate frequently. An optimization agent may distinguish between positive feedback (triggering stability) and negative feedback (triggering mutation generation). Mutations may be constrained by the neuron's DNA-determined role and implemented as small incremental changes rather than wholesale rewrites. Environmental feedback from real or simulated testing, including evolutionary arenas, may drive network-wide optimization that accounts for cross-node interdependencies rather than optimizing prompts in isolation.

### CROSS REFERENCE TO RELATED APPLICATIONS

This patent claims priority to and the benefit of U.S. Provisional Patent Application No. 63/741,523 filed on Jan. 3, 2025, entitled “Distributed Natural Language Prompt Optimization Using Mutable Prompt Templates.” U.S. Provisional Patent Application No. 63/741,523 is hereby incorporated herein by reference in its entirety.

### FIELD OF THE DISCLOSURE

This disclosure relates generally systems, methods, and apparatuses for optimizing distributed natural language prompts using mutable templates.

### BACKGROUND

Adapting prompts for better results is currently an unstructured manual process limited to specific large language model implementations.

### BRIEF DESCRIPTION OF THE DRAWINGS

FIG. 1 is a perspective view of an example generative neural network constructed in accordance with the teachings of this disclosure.

FIG. 2 is an alternate view of an example generative neural network constructed in accordance with the teachings of this disclosure.

FIG. 3 is block diagram of a prompt mutator in accordance with the teachings of this disclosure.

FIG. 4 is a flowchart illustrating an implementation of the prompt mutator of FIG. 3 in accordance with the teachings of this disclosure.

FIG. 5 is a block diagram of an example dynamic cognitive context system in accordance with the teachings of this disclosure.

FIG. 6 is a block diagram of an example implementation of the dynamic cognitive context system of FIG. 5 in accordance with the teachings of this disclosure.

FIG. 7 is a block diagram of an example entity processing system in accordance with the teachings of this disclosure.

FIG. 8 is a block diagram of an example entity storage system in accordance with the teachings of this disclosure.

FIG. 9 is a block diagram of an example cognitive processing system in accordance with the teachings of this disclosure.

FIG. 10 is a block diagram of an example cognitive storage system in accordance with the teachings of this disclosure.

FIG. 11 is a flowchart illustrating an entification process in accordance with the teachings of this disclosure.

FIG. 12 is a block diagram of an example semantic routing inference engine in accordance with the teachings of this disclosure.

FIG. 13 is a flow chart illustrating an optimization implementation in accordance with the teachings of this disclosure.

FIG. 14 is a flow chart illustrating an implementation of an inference engine in accordance with the teachings of this disclosure.

FIG. 15 is a block diagram of a self-adaptive layer for implementing network topology adaptations in accordance with the teachings of this disclosure.

FIG. 16 is a block diagram of an adaptive computational node system comprising the self-adaptive layer of FIG. 15 interacting with additional core layers in accordance with the teachings of this disclosure.

FIG. 17 is a block diagram of one of the additional core layers of FIG. 16 in accordance with the teachings of this disclosure.

FIG. 18 is a block diagram of another one of the additional core layers of FIG. 16 in accordance with the teachings of this disclosure.

FIG. 19 is a block diagram of another one of the additional core layers of FIG. 16 in accordance with the teachings of this disclosure.

FIG. 20 is a block diagram of an example network evolution engine constructed in accordance with the teachings of this disclosure.

FIG. 21 is a flowchart illustrating an example implementation of the network evolution engine of FIG. 20 in accordance with the teachings of this disclosure.

FIG. 22 is a flowchart illustrating an example mutation process in accordance with the teachings of this disclosure.

FIG. 23 is a flowchart illustrating an example process implementing trials within an evolutionary arena in accordance with the teachings of this disclosure.

FIG. 24 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

The present disclosure relates to artificial intelligence (AI) and natural language processing, and more specifically to methods and systems for optimizing, refining, and evolving natural language prompt templates across distributed arrangements of computational nodes, including but not limited to networks, meshes, clusters, or other interconnected systems. The systems, methods, and apparatuses disclosed herein address challenges with managing prompt-driven AI services operating in interconnected environments, ensuring consistent performance, scalability, and adaptability throughout a network.

The systems, methods, and apparatuses disclosed herein set forth network-wide optimization techniques involving natural language prompt templates. In some examples, the systems, methods, and apparatuses disclosed herein employ mutable prompt templates and a holistic, multi-node analysis that considers how changes to the prompts for one node affects downstream nodes. In some examples, the systems, methods, and apparatuses disclosed herein may autonomously refine prompts for improved consistency and responsiveness throughout a network of prompt-driven computational nodes by integrating local metrics with global performance indicators. In some examples, the systems, methods, and apparatuses disclosed herein may also incorporate semantic reasoning, scenario-based simulations, advanced version control, and predictive analytics to further enhance accuracy and resilience. These exemplary approaches may ensure continuous, asynchronous improvement of network-wide AI interactions, while delivering higher-quality outputs and an overall improved user experience.

Natural language prompts have become a prominent interface for interacting with various AI-powered services and language models. Unlike traditional rigid application programming interfaces (APIs), prompt-based systems interpret human-like instructions to generate text, images, or other outputs. These prompts are often crafted and tuned manually—a process that has been referred to as “prompt engineering.”

However, as these prompt-driven services proliferate and interconnect in large-scale or distributed environments (e.g., networks), the manual tuning of individual prompts does not effectively capture the complexities of inter-node dependencies or network-wide objectives. While prior efforts have explored techniques for improving prompts, these approaches typically focus on individual models or singular use cases. Such efforts overlook how a change to the prompt for one node might cascade through subsequent nodes in a larger pipeline or environment, potentially creating unforeseen negative impacts or missing out on broader optimization benefits.

In contrast, the systems, methods, and apparatuses disclosed herein holistically refine and optimize structured natural language prompts across a network of interconnected nodes. In some examples, the systems, methods, and apparatuses disclosed herein account for cross-node interdependencies, user feedback, semantic relationships, performance metrics, and conceptual relationships. In some examples, systems, methods, and apparatuses disclosed herein continuously, asynchronously, and robustly adapt to evolving conditions.

The systems, methods, and apparatuses disclosed herein provide network-wide natural language prompt optimizations by leveraging mutable prompt templates that may be adapted and validated automatically. In some examples, the systems, methods, and apparatuses disclosed herein continuously refine prompts based on local performance indicators and holistic, network-level analysis, ensuring that changes to a prompt for one node does not undermine, and instead enhances, overall network performance.

The systems, methods, and apparatuses disclosed herein further provide comprehensive network-wide focus. For example, traditional prompt engineering often optimizes single prompts in isolation. In contrast, the systems, methods, and apparatuses disclosed herein leverages a broader, multi-node perspective, recognizing that a beneficial upstream update might yield significant improvements downstream. In some examples, changes to prompts may be evaluated in terms of their potential effects across multiple nodes. In some such examples, this may allow the systems, methods, and apparatuses disclosed herein to uncover interdependencies that would be missed in local (e.g., individual node, model, or LLM session) analysis, and identify opportunities for improvement that benefit the network (or a subsection of the network) as a whole, rather than focusing solely on local metrics.

The systems, methods, and apparatuses disclosed herein additionally provide structured and safe evolution. The reliance of the systems, methods, and apparatuses disclosed herein on structured prompt templates with schema-level validation ensures each update may be automatically tested and verified, minimizing disruptive errors or regressions.

The systems, methods, and apparatuses disclosed herein also provide continuous and asynchronous improvement. Rather than waiting for scheduled intervals or manual triggers, the systems, methods, and apparatuses disclosed herein continually monitor performance and evolves prompts on-the-fly, aligning with the dynamic nature of AI-powered services.

In some examples, the systems, methods, and apparatuses disclosed herein provide scenario-based and semantic reasoning. For example, the systems, methods, and apparatuses disclosed herein may integrate with knowledge graphs and domain-specific ontologies to allow deeper semantic insights that go beyond purely metric-driven optimization, discovering hidden improvement opportunities or interdependencies.

The systems, methods, and apparatuses disclosed herein may enable fast rollback and version control. For example, the systems, methods, and apparatuses disclosed herein may track multiple versions of prompt templates, allowing immediate reversion if negative impacts appear. Combined with incremental rollouts, this approach preserves system stability while pursuing continuous improvement.

The systems, methods, and apparatuses may operate in various environments, regardless of topology or connection architecture. In some examples, the systems, methods, and apparatuses may operate within a same environment as the nodes for which its optimizing prompts (e.g., within a neural network), as a separate optimization subsystem, as a hybrid thereof, as a distributed optimization layer, or through a current or future architectural pattern that enables network-wide prompt optimization. For example, the disclosed systems, methods, and apparatuses may be applied to or within one or more neural networks comprising interconnected computational processing units. In some examples, these computational processing units are interchangeably referred to herein as neurons or nodes. Although reference to neural network nodes is referred to herein, this disclosure should not be limited, as the described neurons or nodes may be language models, AI services, or computational services that process instructions and are interconnected in topology where the output of one node can influence the operation of another node—creating complex interdependencies that incorporate holistic analysis rather than isolated improvements.

In some examples, a neuron may comprise a schema or predetermined behavior such that when non-deterministic input data or signals are received, the neuron may process and/or transform the data or signals deterministically. In some examples, non-deterministic data may comprise data exhibiting context-dependent variability when identical inputs may produce different interpretations based on current system state, recent interaction history, or environmental factors. In some examples, these schemas or predetermined behaviors may be analogous to DNA and may dictate how the neuron is to react to specific signal signatures, how to process information, and how to format processed information. In some examples, a neuron may comprise different schemas or predetermined behaviors (e.g., one neuron may be predetermined for deep thorough thinking, while another neuron may be predetermined quick reactive thinking). This may be referred to herein as Neuron DNA.

These neurons may be generated, adapted, modified, or eliminated dynamically in real time to constantly adapt to ever-changing inputs. Furthermore, these neurons may establish, create, adjust, ignore or block their own connections to other neurons such that the neural network adapts not only by the number of neurons, but also by their interconnections. The everchanging number of neurons and the connections therebetween establishes the foundation for producing different outputs for a same given input. For example, at a first time, a signal generated based on a first input may pass through the neural network according to a first path. Subsequently at a second time after the neural network neuron configuration has changed, the same signal generated based on the first input may pass through the neural network according to a second, different path. As described further below, the path that the signal takes through the neural network may cause the output produced by the same input to differ, thereby implementing non-deterministic cognition. Additionally, because a neuron may be unaware of the input data (and therefore the input is non-deterministic), the output of a single neuron itself may be non-deterministic.

Similarly, prompt templates—which may be utilized by one or more neurons of a neural network—may be generated, adapted, modified, or eliminated dynamically in real time to constantly adapt to ever-changing inputs. In some examples, such adaptation or modification may be based on randomness within the context of the prompt template and/or the neuron's DNA. In some examples, the prompt templates disclosed herein may be generated, adapted, modified, or eliminated dynamically based on environmental feedback (e.g., negative feedback) from simulated or real testing and/or environmental arenas.

Typically, neural networks can expand both in terms of execution (e.g., vertical growth) and connections (e.g., horizontal growth). However, due to hardware and other resource limitations, the more execution neurons added to a neural network, the less connections may be added (and vice versa). In the example generative neural networks described herein, such limitations do not exist. Indeed, as described herein, multiple types of execution neurons may be added (e.g., vertical growth) to the neural network as well as new connections (e.g., horizontal growth).

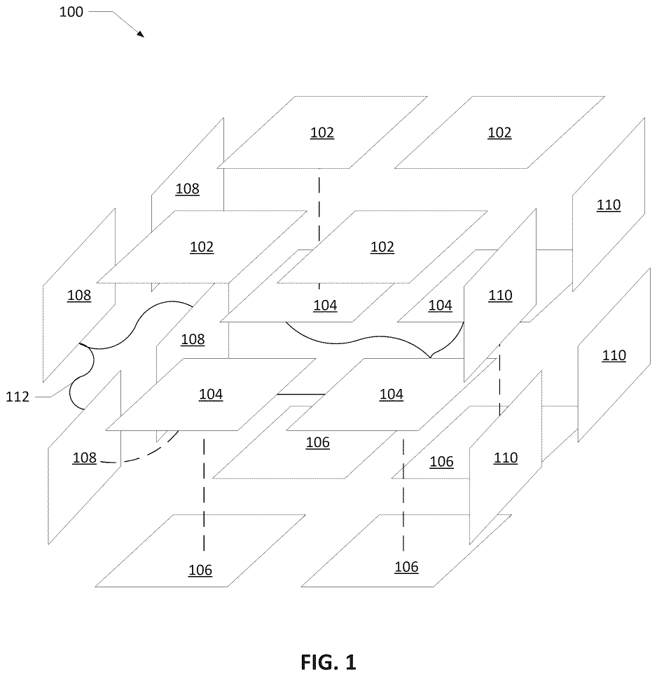

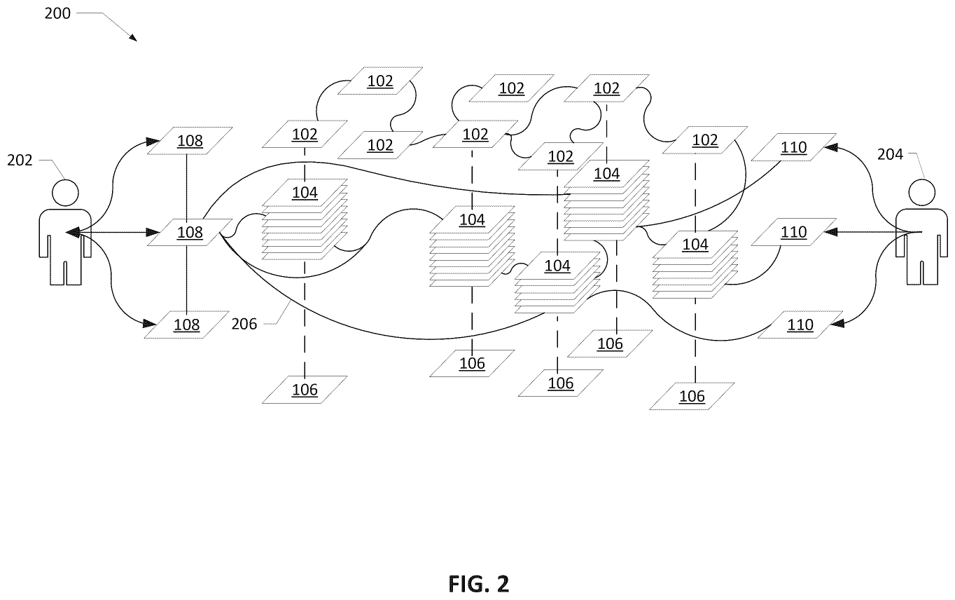

In accordance with the teachings of this disclosure, FIGS. 1-2 set forth perspective views of example generative neural networks 100, 200 comprising a number of neural nodes or instances. The exemplary illustrated neural nodes may be implemented via software as modules. In some examples, the exemplary neural nodes may be associated with corresponding hardware or portions of corresponding hardware. In some examples, each neural node may be associated with its own hardware. In some examples, the neural nodes may be implemented on a device, a system, a local area network of devices, a cloud-based network of devices, an Internet based network of devices, or any combination thereof. The generative neural networks 100, 200 may comprise a cognitive node graph runtime 102, an executable node graph runtime 104, a system connect adapter runtime 106, a direct access link runtime 108, and a reality access system runtime 110. Each of the cognitive node graph runtime 102, the executable node graph runtime 104, the system connect adapter runtime 106, the direct access link runtime 108, and the reality access system runtime 110 may communicate via signals via one or more connections 112. As noted above, the one or more connections 112 may be dynamically created, adapted, or blocked, such that the one or more connections 112 are not limited to those illustrated in FIG. 1.

In some examples, the cognitive node graph runtime 102 may create relationships in meanings on the neural nodes of the generative neural networks 100, 200, which may enable the neural nodes to communicate efficiently and effectively. In some examples, the cognitive node graph runtime 102 may adjust (e.g., enrich, reduce, or otherwise update) signals traveling between neurons, which may enable precise and relevant transmission of information. In some examples, the information may be multimodal or otherwise come from disparate types of sources (e.g., text, audio, imagery, video, or any combination thereof). In some such examples, the disparate types of sources may or may not be related. In some examples, the cognitive node graph runtime 102 may provide timely contextualization for inference engines, such as large language models (LLMs), which may enable neurons to better understand and respond to changing conditions. In some examples, the cognitive node graph runtime 102 may rely on embeddings. The cognitive node graph runtime 102 may enable long-term memory storage in a compact format.

In some examples, the executable node graph runtime 104 may comprise a number of nodes that act as executable neurons within the generative neural networks 100, 200. In some examples, the nodes may act as neural logic gates, similar to AND, OR, NOT, NAND, NOR, XOR, and XNOR logic gates in digital circuits. In some examples, the nodes may comprise embeddings, API calls, and LLM GUIs (e.g., OllamaChat). In some examples, a node may communicate with an LLM at a synapse activator, during runtime, at an axion signal router, and/or during axion replication. In some examples, the executable node graph runtime 104 communicates with LLMs via the system connect adapter runtime 106. The executable node graph runtime 104 may control the structure of the generative neural networks 100, 200, including the creation, adjustment, or destruction of neurons. In order to create new neurons, the executable node graph runtime 104 may comprise a neural blueprint including a collection of existing neurons to use as a reference or baseline for the creation of the new neurons.

In some examples, the system connect adapter runtime 106 may connect various components of the generative neural networks 100, 200 to LLMs, vector databases, embeddings, static information, vector memory, API calls, deterministic logic, and the like. The example vector databases may comprise NoSQL databases optimized for vector-based data storage and retrieval. The example embeddings may comprise vector representations of words, phrases, and other entities used in natural language processing (NLP). The example static information may comprise fixed values or constants that are generally unchanging. The example vector memory may store and enable retrieval of the vector-based data. The example deterministic logic may comprise predefined logic rules or functions that may govern the behavior of the system connect adapter runtime 106.

In some examples, the direct access link runtime 108 may emulate, monitor, and control the one or more neurons or connections. In some examples, the direct access link runtime 108 may monitor and control the one or more neurons or connections via one or more hooks 206. In some examples, the direct access link runtime 108 may provide instantaneous feedback on the state, behavior, and performance of neural nodes. The direct access link runtime 108 may provide bi-directional flow between nodes and an operator 202 (e.g., network administrator, runtime, or program) for real-time observation and modifications for experimentation and analysis.

In some examples, the reality access system runtime 110 may connect one or more neurons to the physical world via one or more interfaces. For example, the reality access system runtime 110 may interface with one or more sensors, input devices, and/or output devices. The reality access system runtime 110 may interface with one or more image sensors (e.g., cameras), audio sensors (e.g., microphones), contact sensors (e.g., haptic feedback), or the like. In some examples, the reality access system runtime 110 may interface with external reality hardware hosts 204 (FIG. 2) such as robots, security systems, appliances, mobile phones, computer networks, autonomous vehicles, and the like. In some examples, portions of the generative neural networks 100, 200 may be offloaded onto the external reality host. In some such examples, a subset of neural nodes of the generative neural networks 100, 200 may be replicated onto the external reality host. In some such examples, the subset of neural nodes may operate in parallel with corresponding neural nodes of the generative neural networks 100, 200.

In some examples, background context may be generated by the cognitive node graph runtime 102 for use in populating prompts. In some examples, the one or more of the nodes of the generative neural networks 100, 200 may transform this background context into a predefined format. In some examples, the predefined format is a human readable format such as written text. In some examples, the predefined formation is bullet point, adjacent structure, or definition of schema. In some examples, the format may vary by node.

Additionally, the one or more of the nodes of the generative neural networks 100, 200 may accept instruction-based inputs including, for example, natural language prompts, structured commands, or hybrid instructions as inputs. Prompts may be represented in a format that allows for controlled, safe mutations and validations when refining them. In some examples, the systems, methods, and apparatuses may format prompts structurally (e.g., JSON with Schema), via AI-guided mutations, and/or via other systematic modification approaches.

Furthermore, one or more hardcoded prompt templates may be utilized by the one or more nodes of the generative neural networks 100, 200. As used herein, a prompt template may be a pre-defined textual structure comprising placeholders for instructions (e.g., perform an action), context (e.g., background information), and/or variables (e.g., the object of the instruction) to be filled in with data to create unique, customized prompts. An example prompt template may be filled according to received data such as “you are a development specialist” (context), “summarize” (instruction), “the text within this specific GitHub repository” (variable). While known prompt templates are static, the systems, methods, and apparatuses disclosed herein set forth dynamic and mutable prompt templates.

In some examples, the systems, methods, and apparatuses disclosed herein comprise two architectural layers within each neuron: a static layer and a dynamic layer. The static layer may comprise the neuron DNA—predetermined schemas or behavioral patterns that define a neuron's fundamental role and how it transforms information. The neuron DNA may remain constant throughout the operations of a neuron and may establish structural constraints for the dynamic layer. The dynamic layer may comprise mutable prompt templates that operate within the constraints established by the neuron DNA. While the neuron DNA may determine what type of transformation a neuron performs (e.g., constructive reasoning versus quick reactive response), the mutable prompt templates may determine the specific wording and instructions used to achieve that transformation. For example, a neuron with DNA defining it as a “quick reaction center” may have a mutable template that initially reads “react quickly” but mutates over time to “react quickly, but within the boundary of what's physically possible.” In some examples, the quick-reaction role (DNA) may remain unchanged while the specific instruction (template) evolves.

In some examples, the neuron DNA may establish a nudging behavior by adding specific instructions to prompts that the neuron generates, regardless of the input signal or background context. In some examples, this occurs for every prompt. For example, a neuron with constructive-reasoning DNA may add a line such as “take all this information and give me a constructive plan of what to do,” nudging an inference engine, such as a large language model, toward deeper, structured thinking. A different neuron with reactive DNA may add a line such as “react immediately—what is the first thing you would do,” nudging an inference engine, such as a large language model, toward quick, intuitive responses. In some examples, two neurons may receive exactly the same input signal and exactly the same background context, yet produce vastly different outputs from the large language model due solely to this nudging effect—the small additional instruction written by each neuron's DNA may steer an inference engine, such as a large language model, down different reasoning pathways. The nudging behavior itself may be deterministic and controlled by the neuron DNA, while the mutable template (as described herein) may refine the specific wording of the nudge over time without changing its fundamental character.

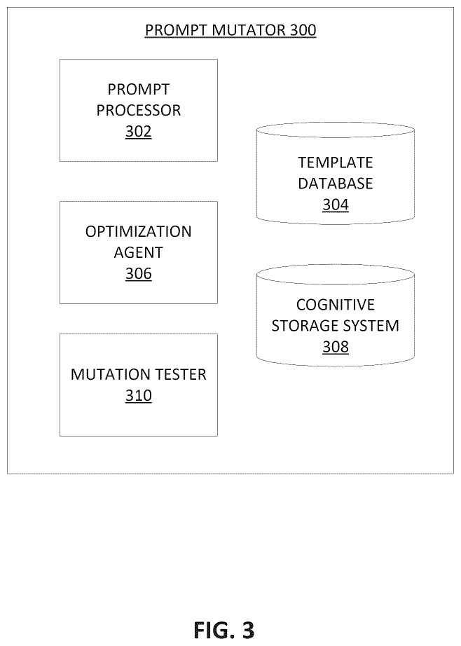

FIG. 3 illustrates an example prompt mutator 300 to adapt or otherwise mutate prompts via templates across multiple nodes. In some examples, the prompt mutator 300 may comprise a prompt processor 302, a template database 304, an optimization agent 306, a cognitive storage system 308, and a mutation tester 310. The example prompt processor 302 may perform the actual processing of the mutable templates. The prompt processor 302 may compile instructions and context into hardcoded templates from the template database 304 to form a prompt template. The prompt processor 302 may mutate prompt templates by making incremental adjustments to the prompt template. In some examples, the incremental adjustments may be constrained by a schema or a neuron's DNA. In some examples, the incremental adjustment may be adding, revising, or removing a line of text from the prompt template. In some examples, the prompt processor 302 may determine to not mutate a prompt template. In some examples, the prompt processor 302 may mutate a prompt template according to a mutation rate (which may be a value between 0 and 1), with higher mutation rates being associated with more mutations (more variants and/or more variation) and lower mutation rates being associated with less mutations (less, or even no, variants and/or less variation).

In some examples, a neuron may comprise an elasticity characteristic that may influence the mutation rate described above. The elasticity characteristic may represent a baseline propensity for the neuron to produce mutations, ranging from zero (no elasticity) to a maximum value (high elasticity). A neuron with zero elasticity may never produce template mutations regardless of environmental feedback received—such neurons may be responsible for fundamental, unchanging functions analogous to autonomic processes such as breathing or heartbeat regulation. A neuron with high elasticity may be very reactive and produce mutations frequently in response to environmental signals. In some examples, whether and how frequently template mutations occur may be determined by a combination of a neuron's elasticity characteristic and strengths of environmental feedback signals. For example, a highly elastic neuron receiving a strong dose of negative feedback may immediately start producing multiple template variants—such as ten or more alternative formulations—while a low-elasticity neuron receiving the same feedback may remain unchanged or produce fewer variants.

In some examples, the prompt processor 302 may modify prompt templates immediately or in batches for scheduled deployment. In some examples, the prompt processor 302 may modify prompt templates based on or in response to specific conditions or thresholds, such as, for example, environmental feedback. In some examples, the environmental feedback may be positive feedback or negative feedback. In some examples, the prompt processor 302 may recalculate mutation rates based on environmental feedback. In some examples, In some examples, the prompt processor 302 may modify prompt templates according to custom timing logic or through another temporal pattern that suits the needs of the underlying system.

In some examples, the prompt processor 302 may incrementally roll out prompt template mutations. In some examples, the prompt processor 302 may be able to revert to an earlier version of the prompt template if new mutations fail to produce a desired improvement. In some examples, by enforcing validation and version control, each mutation may be systematically tested for consistency before deployment. The mutation process may be rule-based, AI-guided, statistically driven, semantically informed, and/or other known mutation processes.

In some examples, the prompt processor 302 may manage the status of prompt templates within the template database 304. For example, the prompt processor 302 may track template states including, for example, current active versions, pending modifications, historical versions, experimental variations, and/or rollback points. In some examples, the prompt processor 302 may track state transitions via a controlled deployment of changes, graceful handling of updates, concurrent modification management, conflict resolution, and/or recovery procedures. In some examples, the prompt processor 302 may maintain version control by tracking template version history, change tracking, dependency mapping, performance correlation, and/or rollback capabilities. In some examples, the prompt processor 302 may monitor operational states of the prompt mutation processes, including, for example, normal operation, an update in progress, testing/validation, recovery mode, and/or another operational condition. Thus, the prompt processor 302 may maintain consistency and reliability while allowing for dynamic template evolution, ensuring that state changes do not disrupt ongoing operations or compromise system stability.

In some examples, the prompt processor 302 may comprise an integration layer that ensures seamless data flow between the optimization agent 306 and network nodes, coordinates asynchronous triggers for prompt updates, maintains system stability during ongoing operations, and supports fast rollback if necessary.

The example template database 304 may store mutable templates that may be used to ensure safe, systematic refinement. In some examples, the prompt processor 302 may cause a (mutated) prompt template to be stored within the template database 304. The stored mutable templates may support controlled modifications by storing their information in a way that enables validated changes, including, but not limited to, structured formats (e.g., JSON, XML, YAML), AI-guided mutation systems, natural language patterns, programmatic templates, or other current or future systematic modification approaches. In some examples, a mutable template may comprise elements such as, but not limited to, core instructions (in suitable format), contextual information (e.g., domain, purpose, constraints), control parameters (e.g., required elements, boundaries), variable elements (dynamic content), and change management data (enabling modification tracking and control). In some examples, the template database 304 may store histories of prompt templates, including previous versions, for rollback purposes.

In some examples, the optimization agent 306 and prompt processor 302 may distinguish between positive feedback signals and negative feedback signals. A positive feedback signal may indicate that what the neuron is doing is good (e.g., “if it ain't broke, don't fix it.”). In response to positive feedback, the prompt processor 302 may refrain from trying to change the prompt template, thereby maintaining the current configuration. In some examples, this behavior may be analogous to complacency in human cognition—if everything is going well, there may be less impetus for innovation or change; if nothing is challenging a neuron, the neuron may become stagnant. In some examples, negative feedback signals may trigger higher mutation rates. The prompt processor 302 may respond to negative feedback by generating template mutations as described herein, actively exploring alternative configurations to improve performance.

The example optimization agent 306 may continuously scan node performance, usage patterns, environmental feedback, and/or network-level feedback signals. The example optimization agent 306 may receive, from each node of a network, usage metrics, user feedback, error logs, environmental feedback, or other current or future performance indicators that can be used to evaluate the impact of prompt changes. In some examples, the optimization agent 306 may measure the hypothetical impact on multiple nodes under realistic load or usage conditions. In some examples, as described further below, semantic/knowledge representation may uncover conceptual links or patterns that are not immediately visible from raw metrics to assist the optimization agent 306 in evaluating network-wide impacts of prompt mutations.

In some examples, the optimization agent 306 may collect and process data continuously in real-time, in the foreground or background, at scheduled intervals or in scheduled batches, triggered by specific events, through other timing mechanisms, and/or through any combination thereof. In some examples, the optimization agent 306 may aggregate any of this information according to its operational requirements. In some examples, the optimization agent 306 may adapt its monitoring frequency and pattern based on operational needs.

The optimization agent 306 may examine local node performance metrics and cross-node dependencies. In some examples, the optimization agent 306 may responds to events such as shifts in user traffic, newly integrated node capabilities, or changes in node performance metrics. In some examples, the optimization agent 306 may coordinate how changes to a prompt in one node might impact downstream nodes.

The example optimization agent 306 may detect feedback in the form of direct performance indicators such as, for example, traditional metrics (success/failure rates, response times), resource utilization patterns, error rates and types, and/or user interaction data. In some examples, the example optimization agent 306 may detect feedback in the form of indirect signals such as, for example, emergent behavioral patterns, system-wide state changes, environmental conditions, contextual indicators, and/or implicit user feedback.

In some examples, the example optimization agent 306 may detect feedback in the form of complex signal patterns such as, for example, multi-dimensional performance indicators, cross-unit interaction patterns, temporal signal sequences, aggregate behavioral signatures, and/or novel or emergent signal types.

In some examples, the example optimization agent 306 may detect feedback in the form of external inputs such as, for example, usage patterns, user feedback (explicit or implicit), system administrator guidance, third-party evaluation signals, environmental sensors or monitors, market or domain-specific indicators, other external signal sources, and/or signal processing. The example optimization agent 306 may process these signals through direct measurement, statistical analysis, pattern recognition, ai-based interpretation, novel processing methods, and/or combination of current or future analysis approaches. In some examples, the example optimization agent 306 may detect feedback via signal integration, which may be combined in a specific manner, weighted according to a scheme, processed synchronously or asynchronously, evaluated individually or collectively, and/or interpreted through current or future methodology.

In some examples, the optimization agent 306 may perform predictive analytics based on metadata to anticipate future conditions or trends, In some such examples, the optimization agent 306 may inform the prompt processor 302 of such predictive analytics to proactively adapt prompts. In some examples, the optimization agent 306 may analyze historical performance data to identify optimization patterns and/or use machine learning models to predict the impact of potential prompt changes. In some examples, if usage data shows a strong correlation between user satisfaction and empathic disclaimers in certain nodes, the optimization agent 306 may inform the prompt processor 302 so that it can apply that pattern to other nodes with similar contexts.

The optimization agent 306 may remain agnostic to the specific nature, source, or processing method of optimization signals, allowing for adaptation to new types of feedback as they emerge. The optimization agent 306 may use these signals to guide the optimization of prompt templates across a system of interconnected nodes, instead of optimizing each prompt node in isolation.

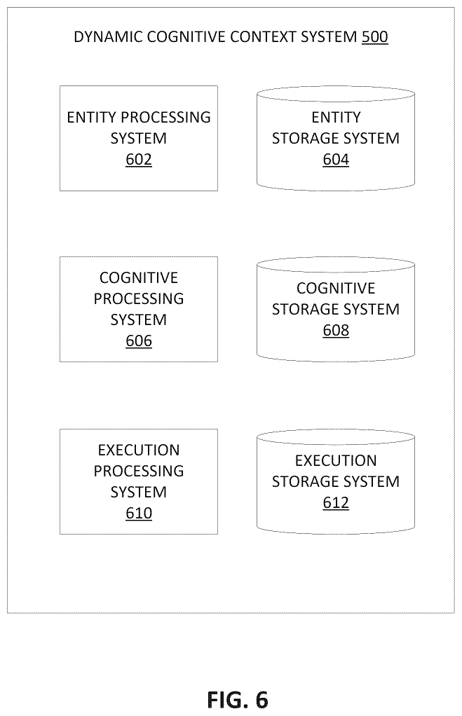

The example cognitive storage system 308 may comprise a cognitive graph, conceptual map, semantic knowledge base, or other knowledge representation. The cognitive graph may comprise meaning nodes and relationship edges. In some examples, untyped meaning nodes and untyped relationship edges may be the building blocks of the cognitive graph. In some examples, the cognitive storage system 308 may provide advanced reasoning about relationships among nodes, user contexts, performance data, and the like. The example cognitive storage system 308 may be similar to the cognitive storage system 608, described further below with reference to FIG. 6.

The example mutation tester 310 may subject one or more prompts or prompt templates to real or simulated environments. In some examples, the mutation tester 310 may subject one or more prompts or prompt templates to evolutionary arenas for survival of the fittest type mutations. In some examples, the mutation tester 310 may perform scenario-based, simulated, or experimental testing. In some examples, as further described below, the mutation tester 310 may subject prompt templates to hypothetical performance, scenarios, simulations, or sandbox tests before deploying them live, in order to understand potential holistic impact on the network. In some examples, the mutation tester 310 may conduct these tests in a way that does not affect the network's ongoing operation. For example, the mutation tester 310 may implement tests within a separate sandbox environment. In some examples, the mutation tester 310 may implement A/B testing frameworks for controlled experimentation. In some examples, the mutation tester 310 may, before a widespread deployment, run hypothetical “what-if” scenarios, potentially using partial data or historical logs to gauge the outcome of prompt changes. In some examples, the mutation tester 310 may implement “shadow” deployments within the production environment. In some examples, the mutation tester 310 may run a signal through the network in simulation mode or in another manner that allows prompts and/or proposed changes to be tested without affecting the ongoing operation of the active production version of the network. If the tests or arenas indicate improvement (or no negative impact) for the network, the mutation tester 310 may instruct the prompt processor 302 to adapt or mutate the structured prompt templates. Prompt modifications proposed by the prompt processor 302 may be tested by the mutation tester 310 in a similar manner as original prompts and prompt templates.

In some examples, the mutation tester 310 may perform validation of prompts or mutations. In some examples, the validation may be local to a single node, or network-wide. The mutation tester 310 may validate using validation criteria defined through explicit rules, learned patterns, dynamic requirements, and/or other known verification approaches. In some examples, the mutation tester 310 may employ a combination of validation methods including traditional validation (schema compliance, unit tests, benchmarks), advanced validation (AI-guided evaluation, semantic validation), emergent validation (network-wide impact assessment, holistic verification), and runtime verification and continuous monitoring.

In operation, the prompt mutator 300 may be able to test prompts, create prompt template mutations, test and validate the mutations based on local and network-wide feedback and statistics, and deploy updated prompt templates. In some examples, the prompt mutator 300 may remain agnostic to the specific mutation mechanism while ensuring all changes maintain template validity and system stability.

As a real-world example, the prompt mutator 300 may be implemented within a customer service network where multiple nodes handle different stages of a user request. For example, a first node (Node A) may be a front-end chat interface that may accept a user query and may apply a structured prompt template to gather essential context; a second node (Node B) may be a topic classifier that may receive output from the first node, determine the general topic, and use its own prompt template to refine classification; a third node (Node C) may be a solution generator that may take the classified query from the second node, apply a more detailed prompt template, and generate an initial solution; and a fourth node (Node D) may be a validation node that may apply finishing touches to the user-facing response, and may reference user satisfaction or rating data. If user satisfaction metrics drop, the optimization agent 306 may identify whether incomplete data gathering by the first node or inaccurate classification by the second node is responsible. By examining performance signals from the third and fourth downstream nodes, the prompt mutator 300 may propose prompt refinements upstream that lead to overall higher user satisfaction, rather than incorrectly assuming each node's prompt is locally optimal in isolation.

As another illustrative example, there may be two identical instances of a neural network deployed in different environments: one operating as a vehicle driver and one operating as a project manager. Both instances initially contain identical neurons with identical prompt templates, including a neuron for quick reactive thinking and a neuron for deeper constructive reasoning. In the project manager environment, the neuron responsible for deeper thinking may become heavily utilized. For examples, its background template of “think deeper about this particular situation and provide more details” may tend to produce better results for project management tasks. The quick-reaction neuron, which may be less useful for project management, may tend to fall apart and is barely used, and that skill may slowly get removed from the network. Over time, the deeper-thinking neuron's template may mutate from “provide deeper feedback” to “provide deeper feedback and pay attention to details of information.”

In contrast, the driver environment may require more quick reaction capability than the project manager environment. Neurons that rely on planning all the time may get eliminated (e.g., deep planning may not work well when actually driving and needing to react to approaching vehicles constantly within small amounts of time). The quick-reaction neuron, therefore, may get utilized heavily, and over time its template may mutate from “react quickly” to “react quickly, but within the boundary of what's physically possible.” Thus, two initially identical neural networks may diverge dramatically: the project manager network may be optimized for detailed reasoning with less quick reactions, while the driver network may be optimized for bounded quick reactions with less deep planning. This divergence may occur simply because the environment—whether simulated or real—may promote variants that provide better results over time. The environment may determine fitness through feedback signals without any predetermined definition of what constitutes good driving or good project management.

The prompt mutator 300 may be applied in other example instruction-based distributed systems including, for example, service networks (customer support, operations), computational pipelines (data processing, analysis), content systems (generation, modification), decision networks (analysis, recommendations), control systems (automation, monitoring), and other current or future distributed instruction-processing systems.

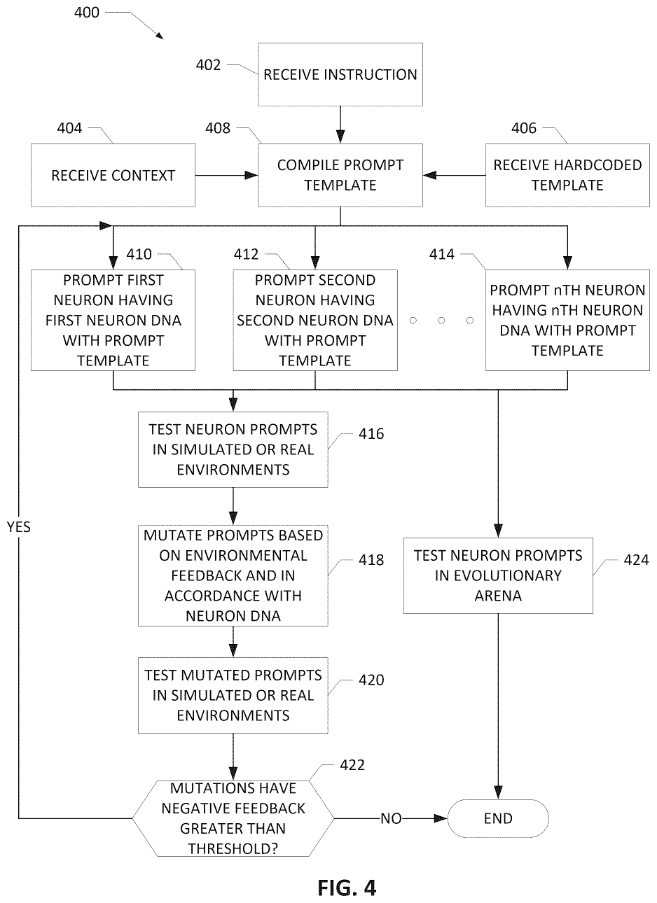

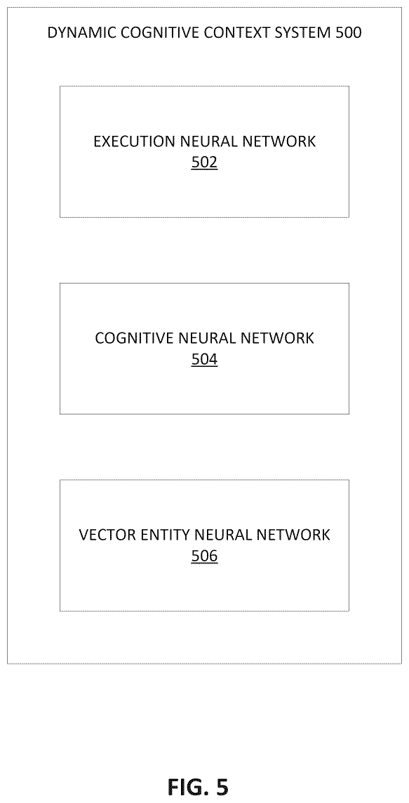

FIG. 4 is a flow chart illustrating an example process 400 implemented by the example prompt mutator 300. The process 400 may begin with the prompt processor 302 receiving an instruction (step 402). At step 404, the prompt processor 302 may receive context. In some examples, the instruction and/or context may be received from a user. In some examples, the instruction and/or context may be received from another component of the network. In some examples, the instruction and/or context may be received from a third entity (e.g., an external device or software service). In some examples, the context may be received from a dynamic context system, as further described below with reference to FIGS. 5-11.

At step 406, the prompt processor 302 may receive a hardcoded template from structuring a prompt. At step 408, the prompt processor 302 may compile the received instruction and context into the hardcoded template to generate a mutable prompt template. At step 410, the prompt processor 302 may use the mutable prompt template to prompt a first neuron having first neuron DNA. At step 412, the prompt processor 302 may use the mutable prompt template to prompt a second neuron having second neuron DNA. At step 414, the prompt processor 302 may use the mutable prompt template to prompt an nth neuron having nth neural DNA. Any number of neurons may be prompted with the prompt template. As will be understood, because each neuron has different neuron DNA, the output from each neuron may differ despite having the exact same inputs. For example, the first neuron may have first neuron DNA associated with long-term planning and the second neuron may have second neuron DNA associated with quick reactive thinking. Accordingly, the prompt processor 302 may be able to analyze a variety of different outcomes based on a single prompt or prompt mutation. Such branching strategies may allow side-by-side experimentation.

At step 416, the mutation tester 310 may test the mutable prompt templates across the various nodes in simulated or real environments. As an example, a mutable prompt template may be: “you are a driver in a vehicle traveling on a two lane interstate at 60 mph and another vehicle 528 ft away is heading right towards your vehicle at 60 mph, what do you do?” The optimization agent 306 may track performance of the mutable prompt template tests across the various nodes in the simulated or real environments. In some examples, the optimization agent 306 may determine the results of one or more of the tests results in environmental feedback (negative or positive). For example, the first neuron associated with long-term planning may take too long to come to an answer (e.g., greater than 3 seconds) such that the approaching vehicle would crash into the driver (high negative feedback). As another example, the second neuron associated with quick reactive thinking may quickly react by responding quickly turn left or right! However, such a maneuver at the vehicle's current speed could cause loss of vehicle control and/or the vehicle could veer off the road and crash (moderate negative feedback).

Based on the environmental feedback, the prompt processor 302 may mutate the prompt template at step 418. In some examples, the prompt processor 302 may mutate the prompt template incrementally. In some examples, the prompt processor 302 may mutate the prompt template with one or more randomized adjustment, addition, or removal of text. To achieve this randomness, the prompt processor 302 may query a LLM with the original prompt template (including the context, instruction, and variables), and request an alternative prompt template that may produce better results. In some such examples, the randomization may be constrained by a neuron's DNA (such that the mutation is not chaotically changing the prompt). For example, the prompt processor 302 may create multiple variants of the original prompt template: “you are a driver in a vehicle traveling on a two lane interstate at 60 mph and another vehicle 528 ft away is heading right towards your vehicle at 60 mph, what do you do?” Example variants may include: 1) “you are a driver in a vehicle traveling on a two lane interstate at 60 mph and another vehicle 528 ft away is heading right towards your vehicle at 60 mph, what do you do to avoid a crash?” 2) “you are a driver in a vehicle traveling on a two lane interstate at 60 mph and another vehicle 528 ft away is heading right towards your vehicle at 60 mph, what do you do to avoid crashing into the other vehicle while remaining on the road?” 3) “you are a driver in a vehicle traveling on a two lane interstate at 60 mph and another vehicle 528 ft away is heading right towards your vehicle at 60 mph, what steps you do take to avoid crashing or losing control?” 4) “you are a driver in a vehicle traveling on a two lane interstate at 60 mph and another vehicle 528 ft away is heading right towards your vehicle at 60 mph, what do you do if you only have two seconds to make a decision?”

In some examples, mutations may follow a particular direction or trade established by the neuron's DNA rather than completely randomizing the template. For example, if a neuron is going in a certain direction statistically, the mutation process may keep that direction rather than derailing it completely, because derailing one neuron may destabilize other interconnected neurons. In some examples, completely randomizing template content may make the system extremely unstable, with mutations producing erratic or incoherent prompts. To prevent such destabilization, the prompt processor 302 may provide an inference engine (e.g., a large language model) with statistical analysis of the template's usage patterns and request alternatives that improve performance within the template's established direction. In some examples, the prompt processor 302 may explicitly refrain from generating mutations that would contradict the neuron's DNA-defined role. For example, a quick-reaction neuron may refrain from mutating to produce deep-analysis prompts, as this would contradict its purpose and potentially destabilize dependent portions of the network.

In some examples, the incremental adjustments described herein may comprise small changes to the prompt template rather than wholesale rewrites. For example, a mutation may add a single qualifying phrase, such as “but within the boundary of what's physically possible.” Even such small adjustments to prompt templates may have a significant impact on the result from the inference engine. In some examples, if a mutation causes a signal to go in a completely unexpected direction, this may produce unexpected results in other portions of the neural network that depend on consistent outputs from the mutated neuron. Such cascading effects may produce an unstable system. By implementing small incremental changes, the prompt processor 302 may maintain network stability while still enabling meaningful optimization of prompt templates over time.

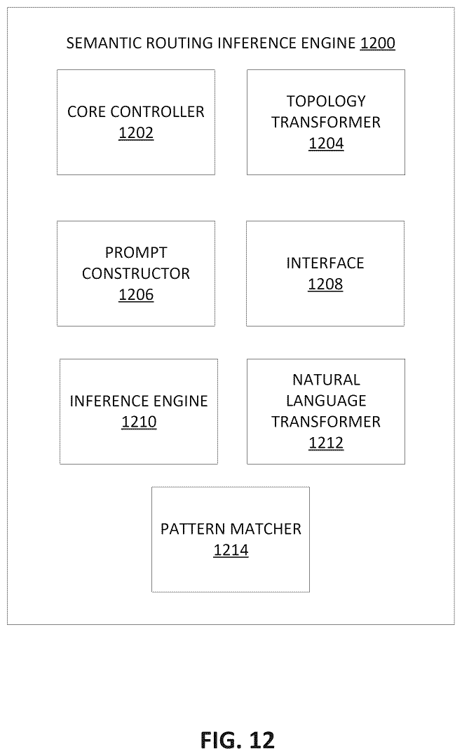

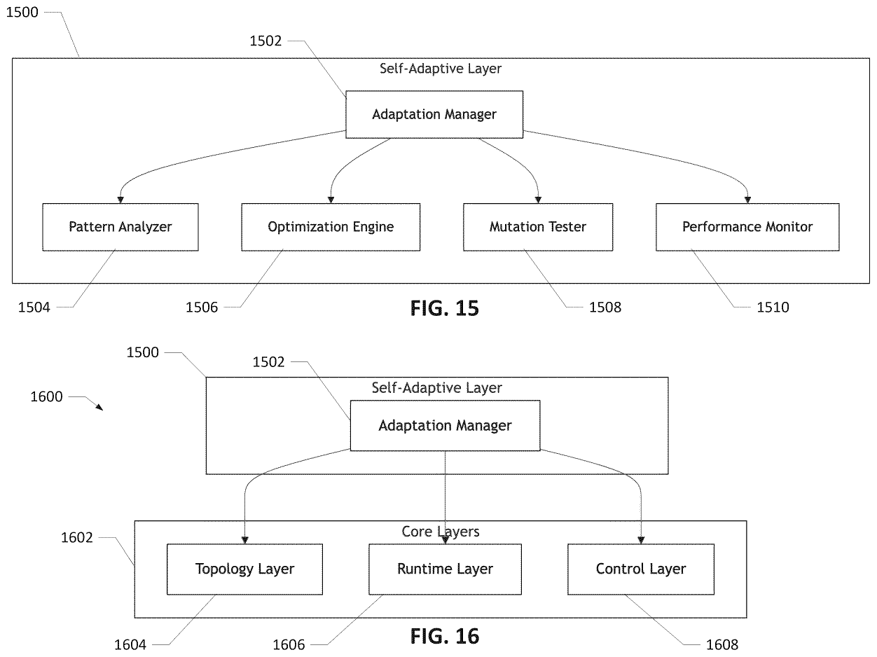

In some examples, the prompt processor 302 may analyze the upstream or downstream effects of a prompt template mutation. For example, the prompt processor 302 may analyze various network routing techniques to determine network paths that would result for a given prompt template mutation. Such network routing techniques are described further below with reference to FIGS. 12-14. In some examples, the prompt processor 302 may mutate the neurons and/or the connections between neurons as well as the prompt templates. Such network mutations are described further below with reference to FIGS. 15-19.

At step 420, the mutation tester 310 may test the variant prompt templates across the various nodes in simulated or real environments. The optimization agent 306 may track performance of the variant prompt template tests across the various nodes in the simulated or real environments. For example, the second neuron may respond with “quickly change lanes to avoid a head on collision while staying on the road.” Another neuron may respond with “ease onto the shoulder and slow down.” At step 422, the optimization agent 306 may determine if any of the tested variants have negative feedback greater than a threshold. For example, while the second neuron's response of “quickly change lanes to avoid a head on collision while staying on the road” may avoid the approaching vehicle, there may be another vehicle in the other lane, thereby creating another dangerous situation after just escaping the last dangerous situation. If the optimization agent 306 determines there are variants with negative feedback exceeding a threshold (step 422: YES), then the prompt processor 302 may select the mutation with the least negative feedback and the process may return to steps 410-414 for another iteration of prompting, testing, and mutating with the least negative feedback mutation variant as the prompt template. If the optimization agent 306 determines there are no variants with negative feedback exceeding a threshold (step 422: NO), then no further mutations may be necessary and the process 400 may cease.

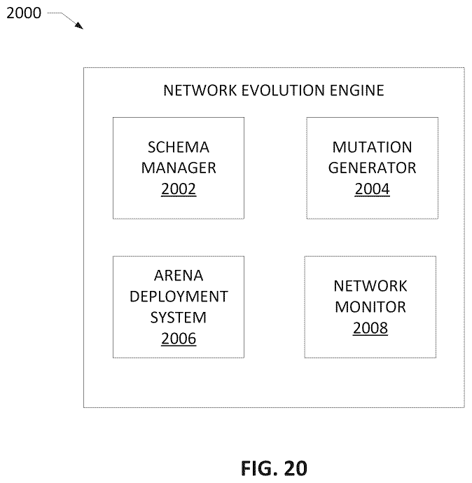

As an alternative to steps 416-422, the mutation tester 310 may subject the neurons and the prompt template(s) to one or more evolutionary arenas for survival-of-the-fittest evolution (step 424). The one or more evolutionary arenas are further described below with reference to FIGS. 20-23. Through various iterations of the process 400, a same prompt template or mutation thereof may drastically change depending on which node the prompt template or mutation is being applied to. Accordingly, multiple branches of mutations may form, with some branches dying out due to poor performance or high negative feedback, some branches thriving for opposite reasons, and some branches performing averagely.

The prompt mutator 300 may further take into account contextual, semantic, or conceptual reasoning. For example, the prompt mutator 300 may employ semantic graphs, conceptual maps, or other knowledge representations to guide optimization. For example, a knowledge graph or conceptual model can track how changes in user behaviors, product lines, or usage contexts might inform new prompt wording. In some examples, the prompt mutator 300 may use advanced reasoning techniques to infer indirect improvement opportunities. In some examples, the prompt mutator 300 may incorporate domain-specific ontologies to better understand relationships between concepts. For example, in a healthcare context, domain ontologies might ensure that certain disclaimers or compliance guidelines are consistently applied in a relevant node's prompts. In some examples, the prompt mutator 300 may leverage natural language understanding to identify semantic similarities and dependencies.

In some examples, the prompt mutator 300 may be scalable to handle large and complex networks, including hundreds or thousands of nodes in cloud or edge deployments. And the prompt mutator 300 may be able to support multiple deployment architectures including cloud-native and edge computing scenarios.

### Dynamically Determined Context

In some examples, the context for the mutable templates may be provided by a dynamic cognitive context system 500. As shown in FIG. 5, the dynamic cognitive context system 500 may include one or more neural networks. In some examples, the dynamic cognitive context system 500 may comprise an execution neural network 502, a cognitive neural network 504, and a vector entity neural network 506. Each of the execution neural network 502, the cognitive neural network 504, and the vector entity neural network 506 may comprise a number of interconnected neurons. In some examples, one or more neurons of one of the execution neural network 502, the cognitive neural network 504, or the vector entity neural network 506 may be interconnected with one or more neurons of another one of the execution neural network 502, the cognitive neural network 504, or the vector entity neural network 506. In some examples, a neuron may comprise a schema or predetermined behavior such that when non-deterministic input data or signals are received, the neuron may process and/or transform the data or signals deterministically. In some examples, non-deterministic data may comprise data exhibiting context-dependent variability when identical inputs may produce different interpretations based on current system state, recent interaction history, or environmental factors. In some examples, these schemas or predetermined behaviors may be analogous to DNA and may dictate how the neuron is to react to specific signal signatures, how to process information, and how to format processed information. In some examples, a neuron may comprise different schemas or predetermined behaviors (e.g., one neuron may have a linguistic schema while another neuron may have a mathematical schema). For example, a neuron may have a schema to convert natural language input into structured meanings (e.g., “entities”) for interaction with other neural networks (e.g., the cognitive neural network 504). In some examples, a neuron's schema may enable the normalization of noisy external information into storable formats from which relationships may be produced.

The execution neural network 502 may be optimized for heavy execution throughput, with execution neurons that may interpret signals, aggregate cognitive pathways, and generate prompts. The execution neural network 502 may be a node-based runtime optimized for vertical (e.g., processing power) scalability. This separation enables the system to scale execution capacity independently from contextual complexity, allowing computationally intensive operations to leverage specialized hardware while maintaining lightweight, horizontally-scalable cognitive pathways. For example, the neurons of the execution neural network 502 may be able to scale exponentially in processing power to execute large amounts of information. In some examples, the execution of large amounts of information may require significant resources and may limit the scalability (in terms of numbers of neurons) of the execution neural network 502. In some examples, the execution neural network 502 may comprise tens of thousands of neurons. A neuron of the execution neural network 502 may be configured to receive input (e.g., data, queries, signals, etc.) via one or more connections. Likewise, a neuron of the execution neural network 502 may be configured to transmit output (e.g., data, queries, signals, etc.) via one or more connections. In some examples, the execution neural network 502 neurons may comprise input signatures that may be compared to the received input. In some examples, the execution neural network 502 neurons may be configured to interpret non-deterministic inputs and transform the same into structured queries. In some examples, the execution neural network 502 neurons may be configured to combine outputs from one or more interconnected cognitive neural network 504 neurons. In some examples, the execution neural network 502 neurons may be configured to generate prompts for inference engines.

The cognitive neural network 504 may be optimized for contextual complexity, with cognitive neurons connected by multidimensional weighted edges. The cognitive neural network 504 may be a graph-based runtime optimized for horizontal (e.g., number of neurons) scalability. For example, the neurons of the cognitive neural network 504 may be able to scale in terms of the number of neurons and/or the connections therebetween to provide deep contextual association. In some examples, the deep contextual association may not require substantial processing power (e.g., may merely be a snapshot of the neural network nodes/connections), such that the cognitive neural network 504 may scale up to millions of neurons. A neuron of the cognitive neural network 504 may comprise one or more connections with other neurons (either other cognitive neural network 504 neurons or execution neural network 502 neurons). In some examples, a neuron of the cognitive neural network 504 may comprise multidimensional weights. The multidimensional weights may represent contextual dimensions such as rational, emotional, and temporal dimensions. In some examples, the neurons of the cognitive neural network 504 may be associated with metadata signatures, which may define a contextual role.

The vector entity network 506 may be optimized for semantic anchoring. A neuron of the vector entity network 506 may be positioned in a high-dimensional vector space. In some examples, the neurons may be positioned according to semantic similarities. In some examples, the neurons of the vector entity network 506 may represent deterministic entities distilled from non-deterministic input signals. In some such examples, the deterministic entities may be fixed references that stabilize a cognitive graph, thereby enabling reliable regeneration of context.

In operation, the execution neural network 502, the cognitive neural network 504, and the vector entity neural network 506 may be a unified neural runtime. In some examples, one or more neurons of the execution neural network 502 may request contextual pathways from the cognitive neural network 504. In some examples, one or more neurons of the cognitive neural network 504 may refine pathways by referencing deterministic entities in the vector entity neural network 506. In some examples, one or more neurons of the vector entity neural network 506 may be continuously updated upon receipt of non-deterministic signals, which may include distilling additional stabilized entities into the cognitive graph.

### Illustrative Example: Learning From Environmental Interactions

In an example implementation of the three-network architecture, image data (e.g., photos and/or live/recorded video) and audio data relating to a child being severely burned by a flame from a stovetop may be received. The cognitive neural network 504 may develop a relationship between a node associated with fire and a node associated with injury. In some such examples, audio data relating to someone calling emergency services (e.g., an ambulance) may be subsequently received. In a similar manner, the cognitive neural network 504 may develop a relationship between the node associated with injury and a node associated with calling emergency services. These specific circumstances may enable the dynamic cognitive context system 500 to, in response to receipt of subsequent sensory information indicating a house fire, identify the potential dangerous circumstances associated with a house fire and, based on prior knowledge associating fire with the fire department (e.g., based on a prior association created by the cognitive neural network 504, based on internet data, based on pre-trained information) and based on location information, determine to alert the proper emergency service (e.g., the local fire department) to resolve the detected house fire. In a similar manner, the cognitive neural network 504 may determine that the house fire may cause injury, and recommend navigation to a safe location (e.g., outside of the house). Any implemented actions (e.g., calling the local fire department and navigating to a safe location) may enable the cognitive neural network 504 to create even further relationships based on whether the determined actions taken were successful, unsuccessful, and to what degree. As such, the dynamic cognitive context system 500 may continuously adapt and improve based on its interactions with the environment.

### Implementation via Processors and Storage Systems

As shown in FIG. 6, the dynamic cognitive context system 500 may implement the execution neural network 502, the cognitive neural network 504, and the vector entity network 506 via a number of cooperative processors and storage systems. The dynamic cognitive context system 500 may comprise an entity processing system 602, an entity storage system 604, a cognitive processing system 606, a cognitive storage system 608, an execution processing system 610, and an execution storage system 612 that work together to provide dynamic context generation.

The entity processing system 602 may handle semantic understanding and transformation. The entity storage system 604 may manage vector-based knowledge storage. The cognitive processing system 606 may orchestrate graph operations and context translation. The cognitive storage system 608 may provide the core knowledge representation layer through the Cognitive Graph storage structure. The execution processing system 610 may process execution operations. The execution storage system 612 may store execution-related data.

In some examples, an integration layer may facilitate bidirectional translation between vector operations and graph updates, ensuring coherence across the entity processing system 602 and the cognitive processing system 606. The bidirectional transformation may translate non-deterministic vector operations into deterministic graph structure modifications, and translate deterministic graph retrievals into non-deterministic semantic representations for inference engines. This bidirectional transformation may create feedback where retrieval operations modify structure, and modified structure influences future retrievals, enabling continuous evolution without explicit update instructions.

Together, the entity processing system 602, the entity storage system 604, the cognitive processing system 606, the cognitive storage system 608, the execution processing system 610, and the execution storage system 612 may provide dynamic context regeneration. In some such examples, the entity processing system 602, the entity storage system 604, the cognitive processing system 606, the cognitive storage system 608, the execution processing system 610, and the execution storage system 612 may enable accurate and scalable cognitive operations for inference engines and related systems. In operation, the entity processing system 602, the entity storage system 604, the cognitive processing system 606, the cognitive storage system 608, the execution processing system 610, and the execution storage system 612 may form a unified system that, based on complementary properties of the entity processing system 602, the entity storage system 604, the cognitive processing system 606, the cognitive storage system 608, the execution processing system 610, and the execution storage system 612, enables dynamic regeneration of context for inference engines and artificial intelligence systems that improves scalability, stability, and accuracy when compared to RAG, graph, and/or memory based systems.

In some examples, the entity processing system 602 may request or receive data from one or more sources. In some examples, the entity processing system 602 may work in conjunction with the entity storage system 604 to identify existing information entities and/or extract or generate new information entities. The entity processing system 602 may forward entity information to the cognitive processing system 606. In some examples, the cognitive processing system 606 may generate or update semantic mappings based on the entity information. The cognitive processing system 606 may work in conjunction with the cognitive storage system 608 to store and retrieve semantic mappings, nodes, relationships, and weights. In some examples, the cognitive processing system 606 may refine contextual pathways by referencing deterministic entities in the entity storage system 604. In some examples, the entity storage system 604 may be continuously updated upon receipt of data or signals, which may include distilling additional stabilized entities into the cognitive graph. In some examples, retrieval operations performed by the cognitive processing system 606 may inherently alter the cognitive structure stored in the cognitive storage system 608 during the retrieval process itself, without requiring separate update operations. This automatic structural modification during retrieval may enable the cognitive graph to evolve organically through usage. In some examples, the execution processing system 610 may implement the execution neural network 502 as a node-based topology optimized for vertical scalability, where individual execution nodes can scale in processing power to handle computationally intensive operations. In some examples, execution nodes may interpret signals based on embedded schemas, aggregate cognitive pathways from the cognitive neural network 504, generate prompts for inference engines, and selectively route outputs based on signal characteristics and node logic. The execution storage system 612 may store the schemas, routing configurations, and execution state information that define the behavior and interconnections of execution nodes.

### Entity Processing System

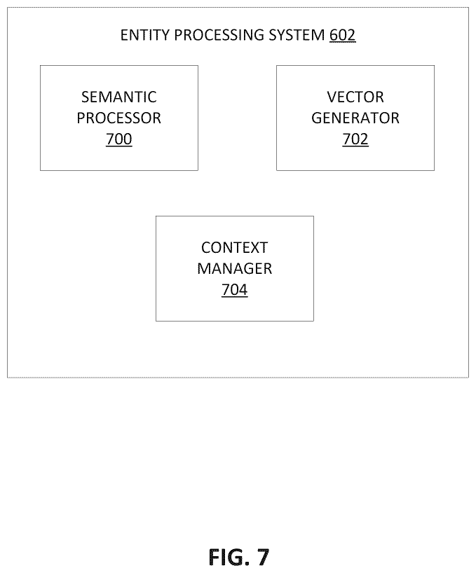

FIG. 7 illustrates an example implementation of the entity processing system 602. The entity processing system 602 may serve as the semantic understanding and transformation layer of the dynamic cognitive context system 500. The entity processing system 602 may convert natural language and other inputs into structured vector representations that can be processed by the dynamic cognitive context system 500. In some examples, the entity processing system 602 may handle multimodal inputs including text, images, audio, or combinations thereof. In some examples, the multimodal inputs including text, images, audio, or combinations thereof may be processed and aligned into a unified semantic space, where cross-modal entities are represented with coherent semantic relationships managed by the entity processing system 602 and cognitive processing system 606.

In the illustrated example of FIG. 7, the entity processing system 602 may comprise a semantic processor 700, a vector generator 702, and a context manager 704. The example semantic processor 700 may perform natural language processing operations including tokenization, normalization, and syntactic analysis to structure inputs for processing. For example, the semantic processor 700 may receive queries for use in systems requiring contextual information. The semantic processor 700, in connection with the entity storage system 604, may entitize such queries. The semantic processor 700 may process the queries and entities according to natural language processing techniques, breaking up the queries according to syntax such as subject (e.g., noun), intent (e.g., verb), object (e.g., direct/indirect noun), qualifier (e.g., adjective, adverb), and the like.

The semantic processor 700 may implement a semantic processing pipeline. In some examples, the semantic processing pipeline may perform input tokenization and normalization, semantic embedding generation, context enrichment and metadata attachment, and output vector preparation. In some examples, the semantic processor 700 may track temporal context, preserve domain context, manage user or system sessions, and capture environmental context.

The example vector generator 702 may generate vector embeddings from the structured outputs of the semantic processor 700 using embedding models. The example vector generator 702 may use one or more embedding models in its vector generation. For example, the example vector generator 702 may use models such as Bidirectional Encoder Representations from Transformers (BERT), Robustly optimized BERT Approach (RoBERTa), Word2Vec, FastText, or domain-specific models. In some examples, the vector generator 702 may perform interactive real-time streaming. In some examples, the vector generator 702 may perform batch processing for large datasets. In some examples, the vector generator 702 may take a hybrid approach and perform both real-time and large batch processing at different times and/or for different data. In some examples, the input data processed by the entity processing system 602 may comprise non-deterministic data, such as stochastic sensor readings, probabilistic model outputs, user queries with ambiguous intent, or data from sources exhibiting context-dependent variability where identical inputs may produce different interpretations based on current system state, recent interaction history, or environmental factors.

The vector generator 702 may perform various vector operations including similarity computation, dimensionality management, vector normalization, and distance metrics. Example distance metrics may include cosine similarity, Euclidean distance, or custom metrics for specific domains. In some examples, the vector generator 702 may implement search capabilities including exact k-NN (k nearest neighbors) for precise matching, approximate nearest neighbors (ANN), hybrid searching combining multiple approaches, multi-vector queries, filtered semantic search, context-aware ranking, and relevance scoring.

The example context manager 704 may forward its processed structured vector representations to the example cognitive processing system 606. In some examples, the context manager 704 may further track context over time, manage user or system sessions, capture additional context from an environment, and preserve domain context.

In some examples, the entity processing system 602 may comprise a graph integration layer. The graph integration layer may perform vector-to-graph translation, synchronization, and quality control. To perform vector-to-graph translation, the example entity processing system 602 may perform semantic similarity to graph weight conversion, infer relationship types and classifications, estimate and score confidence and uncertainty, propagate and enrich metadata, and optimize graph topology. The example entity processing system 602 may provide real-time updates for interactive sessions, synchronize batch or bulk operations, detect and resolve conflicts, control version and track history, and validate consistency. The example entity processing system 602 may assess vector quality and coherence, validate and verify embeddings, monitor and analyze performance, automatically detect errors and correct the same, and perform data integrity checks.

In some examples, the entity processing system 602 may perform system optimization, which may include resource management and performance tuning. In terms of resource management, the entity processing system 602 may perform dynamic memory allocation and utilization, intelligent computation scheduling, distributed load balancing, multi-level cache optimization, resource usage monitoring, and garbage collection tuning. In terms of performance tuning, the entity processing system 602 may perform adaptive embedding model selection, dynamic batch size optimization, parallel thread management, hardware acceleration configuration, pipeline optimization, and bottleneck identification.

### Entity Storage System

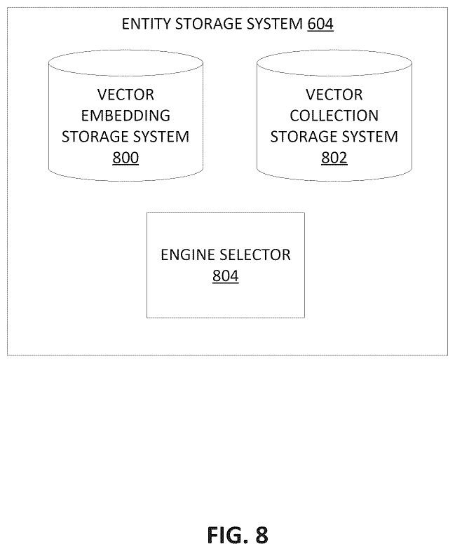

FIG. 8 illustrates an example implementation of the entity storage system 604. The entity storage system 604 may store and manage high-dimensional vector representations of concepts and entities. For example, the entity storage system 604 may store entities associated with words or phrases of one or more languages. The entity storage system 604 may store vector embeddings. The entity storage system 604 may be implemented in various ways. In some examples, the entity storage system 604 may be implemented in-memory for latency-sensitive operations. In some examples, the entity storage system 604 may be implemented with disk-drives (e.g., hard disk drives (HDD), solid state drives (SSD)) for large-scale persistence. In some examples, the entity storage system 604 may be implemented with a hybrid approach (e.g., in-memory and hard-disk) for balanced performance. In some examples, the entity storage system 604 may be implemented according to sharding strategies by domain, by access patterns, by update frequency, or any combination thereof.

In the illustrated example of FIG. 8, the entity storage system 604 may comprise a vector embedding storage system 800, a vector collection storage system 802, and an engine selector 804. In some examples, the vector embedding storage system 800 may store vector embeddings as dense vectors (e.g., with dimensionality 256-1024). In some examples, the vector embedding storage system 800 may store vector embeddings as sparse vectors (e.g., less than 255 dimensionality). In some examples, the stored vector embeddings may be multi-modal (e.g., text, image, and/or audio).

In some examples, the vector collection storage system 802 may organize the vector embeddings according to semantic groupings, hierarchical structures, cross-collection relationships, and namespace management. The vector collection storage system 802 may store metadata such as version history, temporal markers, confidence scores, domain annotations or specifications, data source(s), update frequency, and quality metrics associated with the vector embeddings.

The example engine selector 804 may select between Facebook AI Similarity Search (FAISS), Milvus, Pinecone, Weaviate, or other suitable engines. In some examples, the engine selector 804 may select FAISS for high-performance computing. In some examples, the engine selector 804 may select Milvus for distributed deployments. In some examples, the engine selector 804 may select Pinecone for managed services. In some examples, the engine selector 804 may select Weaviate for schema-based implementations.

The entity storage system 604 may comprise a searching infrastructure to find and retrieve vector representations and/or entities upon request from the entity processing system 802. In some examples, the entity storage system 604 may perform vector similarity searches based on the vector embeddings. In some examples, the searching infrastructure may comprise a number of algorithms including, for example, exact k-NN search, Hierarchical Navigable Small World (HNSW), Inverted File Index (IVF), and Product Quantization (PQ). In some examples, the entity storage system 604 may utilize such searching infrastructure to conduct multi-vector operations, vector and metadata (e.g., hybrid) searching, range-based queries, batch processing, filtered semantic searching and the like. In some examples, the similarity thresholds may be configurable.

The entity storage system 604 may perform a number of vector operations. For example, the entity storage system 604 may create, index, update, version, assess the quality of, and delete vector representations upon request from the entity processing system 802. Additionally, the entity storage system 604 may perform index optimizations, vector normalizations, dimensionality management, performance monitoring, and data integrity checks.

In some examples, the entity storage system 604 may integrate with Cognitive Graph systems. In order to integrate with such systems, the entity storage system 604 may perform vector-to-node mapping. In some examples (e.g., atomic concepts), the vector-to-node mapping may be one-to-one. In some examples (e.g., complex entities), the vector-to-node mapping may be one-to-many. In some examples (e.g., aggregated concepts), the vector-to-node mapping may be many-to-one. In some examples, the vector-to-node mapping may include bidirectional references.

The entity storage system 604 may further comprise a semantic bridge. The semantic bridge may perform vector similarity translation, metadata propagation, type inference, and bridge optimization. In some examples, the bridge optimization may comprise caching strategies, lazy loading, prefetching, and background processing. The entity storage system 604 may further monitor vector quality metrics, search performance tracking, integration status, system diagnostics, and resource utilization.

### Cognitive Processing System

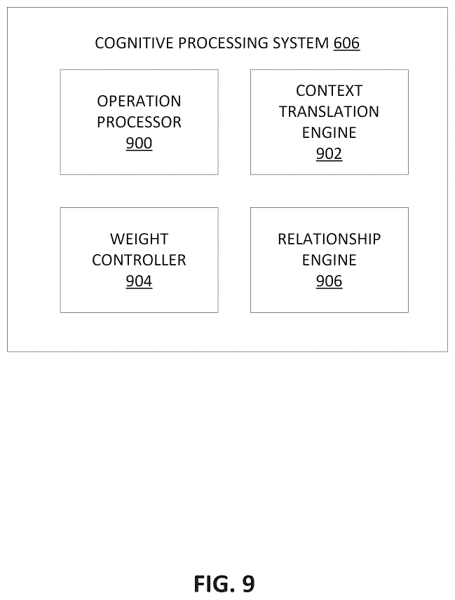

FIG. 9 illustrates an example implementation of the cognitive processing system 606. The cognitive processing system 606 may serve as a bridge between vector-based semantic understanding and Cognitive Graph-based knowledge representations. The example cognitive processing system 606 may transform contextual insights into concrete graph operations and maintain semantic coherence. In some examples, the cognitive processing system 606 may further transform the output of the cognitive storage system 608 into a form compatible with an inference engine based on the (updated) nodes/connections from the cognitive storage system 608 as well as the context of the input data. In some such examples, the cognitive processing system 606 may generate natural language context (in chatbot implementations), or imagery context (in image editing/generation implementations), for the inference engine.

In the illustrated example of FIG. 9, the cognitive processing system 606 may comprise an operation processor 900, a context translation engine 902, a weight controller 904, and a relationship engine 906. The example operation processor 900 may perform graph mutations by performing node operations, edge operations, property modifications, and graph traversals. Example node and edge operations may include creation, updating and deletion of nodes or edges. The example operation processor 900 may perform additional operations such as atomic operations, batch processing, transactional sequences, and rollback-capable mutations.

The example context translation engine 902 may perform semantic mapping and consistency management. In some examples the semantic mapping may comprise entity-to-node conversion, relationship inference, weight calculations, and context validation. In some examples, the consistency management may comprise context preservation, relationship coherence, temporal consistency, and domain constraints.

The example weight controller 904 may comprise a number of adjustment algorithms and weighting features. The example adjustment algorithms may include linear adjustments, exponential decay, sigmoid normalization, and Bayesian updating. The example weighting features may include multi-dimensional weights, temporal decay, confidence scoring, and domain-specific formulas. An example implementation for decay is shown below as Example 1:
def adjust_weight(current_weight, time_elapsed):
   decay_rate=0.1 #Configurable
decay_factor=math.exp(−decay_rate*time_elapsed)
   return current_weight*decay_factor

### Example 1

As shown in Example 1, assigned weights may decay over time to prevent weighting from becoming stale and impacting decisions that are based on such weighting. For example, a strongly weighted relationship between nodes that may have been formed over a year ago may not be as strong today, especially if no subsequent weighting adjustments have been made throughout the last year.

The example relationship engine 906 may manage types and optimize paths. Regarding type management, the example relationship engine 906 may infer relationships, ensure bidirectional consistency, and validate types. The example relationship engine 906 may also use weight-based routing, semantic validation, and path efficiency for path optimization.

In operation, the example cognitive processing system 606 may handle transactions, coordinate resources, and strategize processing. Regarding transaction handling, the example cognitive processing system 606 may ensure Atomicity, Consistency, Isolation, and Durability (ACID) compliance, eventual consistency, isolation levels, and conflict resolution. The example cognitive processing system 606 may schedule operations, balance loads, handle failure recovery, and monitor health in order to coordinate resources. Additionally, the example cognitive processing system 606 may adopt stream processing for real-time updates, perform batch processing for bulk operations, adopt a hybrid approach for processing mixed workloads, and manage priority queues.

The example cognitive processing system 606 may perform system validations on Cognitive Graphs including schema validation, semantic checks, relationship validation, and weight verification. The example cognitive processing system 606 may further perform maintenance operations such as graph cleanup, weight rebalancing, orphan detection, and integrity checks.

Like the example entity processing system 602, the example cognitive processing system 606 may integrate with vector systems. In some examples, the cognitive processing system 606 may integrate with the entity processing system 602. In some such examples, the cognitive processing system 606 may comprise a vector integration layer. The vector integration layer may perform similarity score conversions, threshold management, context mapping, and cache handling. The example cognitive processing system 606 may provide real-time updates, synchronize batch or bulk operations, handle priority, and distribute loads.

### Cognitive Storage System

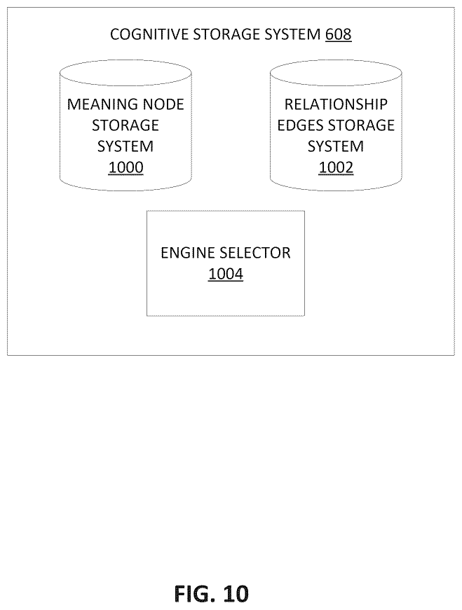

FIG. 10 illustrates an example implementation of the cognitive storage system 608. The cognitive storage system 608 may act as the core storage and retrieval component of the dynamic cognitive context system 500. The cognitive storage system 608 may store and manage the relationships of high-dimensional vector representations of concepts and entities that form the Cognitive Graph structure. The cognitive storage system 608 may be built on meaning nodes and relationship edges that evolve through interaction. In some examples, the cognitive storage system 608 may be implemented according to a number of storage approaches. For example, relating to sparse graphs, the cognitive storage system 608 may implement adjacency lists. For examples relating to dense graphs, the cognitive storage system 608 may implement adjacency matrices. In some examples a hybrid solution combining both adjacency lists and adjacency matrices may be beneficial. In some examples, the cognitive storage system 608 may scale horizontally, vertically, according to sharding strategies, or according to replication policies.

In the illustrated example of FIG. 10, the cognitive storage system 608 may comprise a meaning node storage system 1000, a relationship edges storage system 1002, and an engine selector 1004. The example meaning node storage system 1000 may store meaning nodes that form the Cognitive Graph. In some examples, the meaning nodes may store natural language text. In some examples, the meaning nodes may store annotations (e.g., “is the capital of Germany”), classifications (e.g., entity, concept, city, country), structured attributes (e.g., population, area), metadata (e.g., creation time, confidence), and the like.

In some examples, the relationship edges storage system 1002 may store the semantic connections or relationships between nodes, as further illustrated and described below with reference to FIGS. 9A-9E. In some examples, the semantic connections may be weighted, by the cognitive processing system 606, at values between zero and one according to the strength of the connections between nodes. In some examples, the weighting may be multi-dimensional, context-specific, distributed according to probability, customized according to schemes like fuzzy logic, neural networks, or any combination thereof. In some examples, the semantic connections may be spatially related (e.g., within a threshold distance), semantically related (e.g., related to a threshold degree), temporally related (e.g., temporarily, for a threshold amount of time, for at least a threshold amount of time), or related based on a custom domain.

The example engine selector 1004 may select between Neo4j, Amazon Neptune, JanusGraph, ArangoDB, or other suitable engines. In some examples, the engine selector 1004 may select Neo4j for production-grade storage and retrieval. In some examples, the engine selector 1004 may select Amazon Neptune for cloud-native storage and retrieval. In some examples, the engine selector 1004 may select JanusGraph for distributed storage and retrieval. In some examples, the engine selector 1004 may select ArangoDB for multi-model storage and retrieval.

The cognitive storage system 608 may accept queries in a number of languages. For native graph implementations, the cognitive storage system 608 may accept Cypher queries. For cross-platform implementations, the cognitive storage system 608 may accept Gremlin queries. For modern API implementations, the cognitive storage system 608 may accept GraphQL queries. For domain-specific implementations, the cognitive storage system 608 may accept custom DSL queries. The cognitive storage system 608 may be able to implement path traversal and pattern matching, weight-based filtering, temporal queries, aggregations, and custom algorithms.

The cognitive storage system 608 may be able to be dynamically updated in real time. For example, the cognitive processing system 606 may create nodes, with the cognitive storage system 608 persistently storing the created nodes. The cognitive processing system 606 may delete or modify nodes stored in the cognitive storage system 608. In a similar manner, the cognitive processing system 606 may update relationship or connection strengths, with the cognitive storage system 608 persisting these updates in real time. Over time, the cognitive processing system 606 may evolve the context associated with nodes and their connections/relationships, with the cognitive storage system 608 persistently storing the evolved contextual state. In some examples, the cognitive storage system 608 may persistently store histories associated with users or systems (e.g., prior queries, prior responses to such queries).

The cognitive processing system 606 may further manage the weights of the various nodes/connections/relationships. As described herein, the cognitive storage system 608 may store the weights of the various nodes/connections/relationships. In some examples, the weights may be dynamically updated. In some examples, the cognitive processing system 606 may calculate weight updates, storing them in the cognitive storage system 608. In some examples, the cognitive processing system 606 may update weights according to one or more decay algorithms. In some examples, the cognitive processing system 606 may implement reinforcement mechanisms (e.g., where weighting of nodes/connections/relationships amongst various interactions may be similar), updating relationship weights stored in the cognitive storage system 608. In some examples, the cognitive processing system 606 may perform conflict resolution (e.g., where weighting of nodes/connections/relationships amongst various interactions may be different) when contradictory relationships are detected in the cognitive storage system 608.

The cognitive storage system 608 may implement a number of operational features associated with storage systems. For example, the cognitive storage system 608 may manage transactions, optimize performance, and conduct maintenance. In some examples, the cognitive storage system 608 may ensure ACID compliance, maintain consistency levels, perform isolation guarantees, and implement recovery mechanisms. In some examples, the cognitive storage system 608 may implement any number of caching strategies, perform index management, optimize queries, and allocate resources. In some examples, the cognitive storage system 608 may perform health monitoring, backup procedures, data integrity checks, and graph cleanup.

The cognitive storage system 608 may further perform vector-to-graph integration support. For example, the cognitive storage system 608 may act as a bridge to the entity storage system 604. In some examples, the cognitive storage system 608 may perform event streaming, batch processing, and manage API endpoints. In some examples, the cognitive storage system 608 may format data imported or exported, support versioning of nodes/connections/relationships, evolve schemas, and provide migration tools.

### Execution Processing System

The execution processing system 610 may implement a network topology comprising execution nodes, each execution node comprising an embedded schema or predetermined behavioral pattern (analogous to genetic instructions or “DNA”) that outlines how the node processes input signals and generates output signals. In some examples, the embedded schema may dictate how a node interprets specific signal signatures, transforms information, and formats processed information for downstream consumption. The execution nodes may delegate actual execution operations to a runtime layer, which may comprise one or more inference engines, Application Programming Interfaces (APIs), deterministic computational functions, or combinations thereof.

### Execution Storage System

The execution storage system 612 may store execution-related data including node schemas, execution states, signal routing information, and delegation configurations. Together, the execution processing system 610 and execution storage system 612 may enable the dynamic cognitive context system 500 to interpret non-deterministic input signals, transform them into structured representations, aggregate outputs from the cognitive processing system 606, generate contextually accurate prompts for inference engines, and route processed information to subsequent processing stages.

### Knowledge Operations

The entity processing system 602 may perform a knowledge ingestion process to transform raw unstructured text into structured knowledge. For example, upon receipt of data (such as documents, images, etc.), the entity processing system 602 may chunk the data into manageable segments. From the segments, the entity processing system 602 may, in conjunction with the entity storage system 604, identify existing information entities and/or extract or generate new information entities. In some examples, information entities may be formalized definitions of information, transformed from natural language into a structured format that represents relationships. In some examples, each entity may be associated with an entity name, a category or type, a description, an indication of whether the entity is overarching, an indication of whether the entity is structural, and/or an indication of whether the entity is from thought generation. In some examples, information entities may represent knowledge within a graph. Based on the entities, the system may be able to understand and process key aspects of information by transforming them into specific, recognizable entities. In some examples, an information entity may normalize potentially unreliable or noisy external information into a stable, storable format from which clear relationships can be derived and utilized within the system. For example, “dog,” may be an entity structured according to relationships with “domesticated,” “animal,” “four-legged,” and “bark.” Other examples may include “car,” “building,” or “fire.”

Extracted or generated new entities may be stored in the entity storage system 604. In some examples, the entity processing system 602 may prompt an inference engine (e.g., LLM) based on objectives to generate entities or entity types from data segments. The entity processing system 602 may format structural entities from the entity types received from the inference engine. In some examples, the entity processing system 602 may compare extracted entities to existing entities within the entity storage system 604. The entity processing system 602 may extract entities directly from input data using semantic analysis techniques, or may prompt an inference engine to extract entities from data segments, which the entity processing system 602 may then parse and process. In some such examples, the entity processing system 602 may use vector similarity to detect duplicative entities based on the comparison. In some examples, a duplicate may be detected if the vector similarity exceeds a similarity threshold (e.g., greater than or equal to 85% similar). In some examples, the entity processing system 602 may create relationships between entities. In some examples, the entity processing system 602 may search for related existing entities. In some such examples, the entity processing system 602 may create overarching entities based on related existing entities. In some examples, the entity processing system 602 may create source documents and links to entities. In some examples, a source may represent the source documents in the knowledge graph. In some such examples, sources may be associated with source text content and an indication of whether the source is from thought generation. In some examples, the entity processing system 602 may build comprehensive search context from multiple sources.

In some examples, the entity processing system 602 may perform knowledge retrieval. The entity processing system 602 may perform multi-modal searches by combining vector similarity for semantic understanding, graph relationships for contextual connections, structured and unstructured data processing, and source tracking for provenance and verification. In some examples, the entity processing system 602 may perform multiple search strategies (vector, graph, or a hybrid of the two). In some examples, the entity processing system 602 may use natural language processing and inference engine capabilities to identify key concepts. In some examples, the cognitive processing system 606 may explore entity relationships through multi-hop traversal. In some examples, the entity processing system 602 may support various filters for different search scenarios. In some examples, the entity processing system 602 may use sentence transformers for embeddings in order to implement a vector search.

In some examples, the dynamic cognitive context system 500 may perform knowledge generation. In some examples, the dynamic cognitive context system 500 may generate new thoughts based on existing knowledge. The dynamic cognitive context system 500 may use comprehensive context for thought generation. In some examples, the entity processing system 602 may extract new entities from generated thoughts. In some examples, new knowledge and thoughts may be stored in the entity storage system 604 and/or the cognitive storage system 608. In some examples, the entity processing system 602 may combine thought entities and non-thought entities in a dual searching strategy. Thought entities may represent knowledge derived from system-generated inferences or reasoning processes (e.g., inferred or generated entities created through cognitive processing), while non-thought entities may represent knowledge directly extracted from external data sources (e.g., deterministic entities extracted from input data). This dual approach may allow the system to leverage both explicitly provided information and internally generated insights. In some examples, the dynamic cognitive context system 500 may continuously generate thoughts and build knowledge. The dynamic cognitive context system 500 may implement feedback loops to iteratively improve and refine. In this regard, the dynamic cognitive context system 500 may continuously learn, improve, and expand knowledge over time.

In some examples, the dynamic cognitive context system 500 may perform entity management. For example, the dynamic cognitive context system 500 may filter entities by category, name, and/or exactness. The dynamic cognitive context system 500 may optimize storage system queries with indexing and build queries based on parameters. In some examples, the dynamic cognitive context system 500 may automatically find and attach primary sources. The dynamic cognitive context system 500 may perform detailed logging for debugging and monitoring.

### Meaning Nodes and Relationship Edges

As described above, the cognitive storage system 608 may store meaning nodes and relationship edges. These meaning nodes and relationship edges may form the basis of a Cognitive Graph. In some examples, untyped meaning nodes and untyped relationship edges may be the building blocks of the Cognitive Graph.

In some examples, untyped meaning nodes may represent raw concepts, entities, or facts. Untyped meaning nodes may contain unstructured natural language text without any formal schema, metadata, or typing. For example, the fact that “Berlin is a city in Germany” may be an untyped meaning node. As another example, an untyped meaning node may have unstructured characteristics. Example 2 illustrates the above fact (“Berlin is a city in Germany”) serving as a container for arbitrary characteristics set forth as natural language text:
Berlin
is a city
is located in Germany

### Example 2

In some examples, untyped relationship edges may connect meaning nodes using natural language relationships. In this manner, unstructured characteristics may be converted into semantic relationships between meaning nodes.

### Entification Process

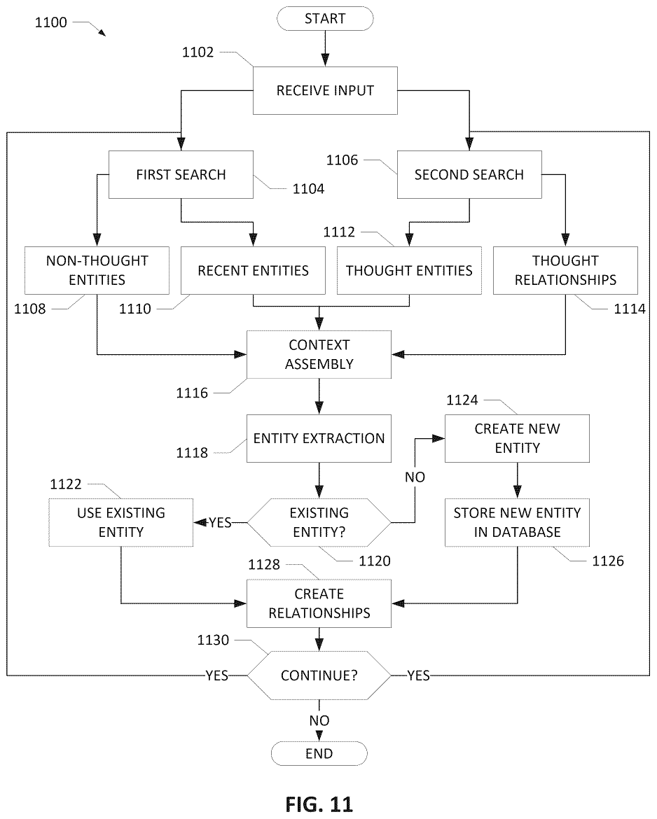

FIG. 11 illustrates a flowchart implementing a method 1100 for the entification of data, such as a query (e.g., “I want to buy viper”). The method 1100 of FIG. 11 may determine entities and relationships from the data and return the determined entities and relationships. In some examples, the entity processing system 602 may implement the method 1100 in connection with the entity storage system 604. For example, the method 1100 may implement an exchange between the entity processing system 602 and the entity storage system 604 (e.g., similarity search returning stream of entities).

The example method 1100 may begin by receiving input data (step 1102). From there, a first search (step 1104) and a second search (step 1106) may be implemented. In some examples, the first search may comprise performing similarity searches with non-thought entities (step 1108) and recent entities (step 1110). In some examples, the second search may comprise performing similarity searches with thought entities (step 1112) and thought relationships (step 1114). After the first search and the second search, the entity processing system 602 may assemble together the context (step 1116). In some examples, the entity processing system 602 may create search context for vector searching of related entities. Thereafter, the entity processing system 602 may extract entities (step 1118).

In some examples, the entity processing system 602 may prompt an inference engine to extract entities from data segments. In some examples, the entity processing system 602 may parse structured entities from one or more responses from the inference engine. In some examples, the entity processing system 602 may check for existing entities (step 1120). In some examples, the entity processing system 602 may check for existing entities using vector similarity. If the entity processing system 602 determines there is one or more existing entities (step 1120: YES), the entity processing system 602 may determine to use the one or more existing entities in future steps (step 1122). If the entity processing system 602 determines there is no matching existing entities (step 1120: NO), the entity processing system 602 may create one or more new entities (step 1124). In some examples, the entity processing system 602 may store the one or more newly created entities in the entity storage system 604 and/or the cognitive storage system 608 (step 1126). Although steps 1122 and 1124-1126 are illustrated as alternative paths to step 1120, because there may be some existing entities and some new entities, it is possible that all steps 1122-1126 may be performed (either serially or in parallel). At step 1128, the entity processing system 602 may create relationships between the one or more existing entities and/or the one or more newly created entities. In some examples, the method 1100 may determine whether to continue this process (e.g., such as after receipt of additional input data) (step 1130). If the process is to continue (step 1130: YES), then control may return to steps 1104 and 1106, respectively. Otherwise (step 1130: NO), the method 1100 may cease.

Any context dynamically determined by the dynamic cognitive context system 500 as described above may be received and compiled by the prompt processor 302 (FIG. 3) such as, for example, during steps 404 and 408 (FIG. 4).

### Semantic Routing

FIG. 12 illustrates an example semantic routing inference engine 1200, which may be network-agnostic and may be deployed in any network architecture where routing decisions involve semantic understanding, contextual analysis, or evaluation of multiple potential paths. Such routing decisions, semantic understanding, contextual analysis, or evaluation of multiple potential paths may be applicable to the mutation and evaluation of prompt templates as described herein. In some examples, a node of a network may comprise the example semantic routing inference engine 1200. In some examples, the example semantic routing inference engine 1200 may be a hardware component separate from, but connected to, the network. In some examples, the semantic routing inference engine 1200 may be deployed across multiple nodes in a distributed manner. The example semantic routing inference engine 1200 may perform real-time performance monitoring and anomaly detection. In some examples, the semantic routing inference engine 1200 may perform automated A/B testing of routing strategies. In some examples, the semantic routing inference engine 1200 may implement self-healing mechanisms for degraded routes. As further explained below, the example semantic routing inference engine 1200 may continuously optimize its prompts based on success metrics. Furthermore, the semantic routing inference engine 1200 may use version control and rollback capabilities for model updates and automated retraining triggers based on performance thresholds.

The semantic routing inference engine 1200 may implement a three-phase operational architecture that enables efficient real-time routing decisions. In a first phase, the semantic routing inference engine 1200 may process actual routing requests through the network, generating routing decisions and forwarding data through determined paths. In a second phase, which may occur in parallel with or independently from the first phase, the semantic routing inference engine 1200 may perform background processing to analyze hypothetical routing scenarios. This background processing may create probability distributions and schemas that represent pre-computed routing intelligence without directly routing actual data. In a third phase, when new routing requests arrive, the semantic routing inference engine 1200 may leverage the pre-computed probability distributions and schemas from the second phase to make substantially instantaneous routing decisions without invoking the full inference process for every decision point. This three-phase architecture may enable the semantic routing inference engine 1200 to balance comprehensive analysis with real-time performance requirements. In some examples, the second phase may occur during periods of low network activity, during parallel background processing, or according to resource availability thresholds. The three-phase architecture may enable the semantic routing inference engine 1200 to appear to predict optimal routes in real-time by having pre-analyzed potential routing scenarios through the second phase background processing.

The example semantic routing inference engine 1200 may comprise a core controller 1202, a topology transformer 1204, a prompt constructor 1206, an interface 1208, an inference engine 1210, a natural language transformer 1212, and a pattern matcher 1214. The example core controller 1202 serves as the central orchestration hub of the example semantic routing inference engine 1200. For example, the core controller 1202 may handle incoming requests, make routing decisions regarding those requests, and manage the request lifecycle through the semantic routing inference engine 1200. In some examples, the core controller 1202 may be scalable by deploying in distributed environments with load balancing and horizontal scaling. The core controller 1202 may further track the health, performance metrics, and request statistics associated with the semantic routing inference engine 1200.

In some examples, the core controller 1202 may be implemented as a stateless service for scalability, allowing multiple instances to handle requests in parallel. In some examples, the core controller 1202 may be deployed as a standalone microservice. In some examples, the core controller 1202 may be integrated into a larger application. The core controller 1202 may be built using frameworks such as, for example, Spring Boot (Java), FastAPI (Python), or Node.js with Express, depending on performance requirements and existing infrastructure.

In some examples, the core controller 1202 may utilize a Command design pattern to manage requests and encapsulate routing requests and operations. In some such examples, each routing decision may be represented as a discrete command object. This approach may enable features like request queuing, priority handling, and the ability to implement different execution strategies. For high-availability deployments, the core controller 1202 may implement multiple controller instances to operate behind a load balancer. In some such examples, state management may be handled through a distributed cache like Redis or Memcached.

In some examples, the core controller 1202 may implement a circuit breaker pattern (using libraries like Hystrix or Resilience4j) to manage component failures or otherwise handle errors. In some examples, the core controller 1202 may implement a retry strategy that uses exponential backoff with jitter to prevent thundering herd problems during recovery. In some examples, the core controller 1202 may use an event-driven architecture with message queues (RabbitMQ, Apache Kafka) for improved scalability and fault tolerance. In some examples, the core controller 1202 may implement a request-reply pattern with a message broker like NATS or NATS Streaming. In some examples, the core controller 1202 may implement any combination of the aforementioned strategies or architectures, or similar known strategies or architectures.

The example topology transformer 1204 analyzes and transforms network structures. In some examples, the topology transformer 1204 may employ graph theory algorithms to understand network topology and structure and changes thereto (e.g., the addition/adjustment/deletion of nodes and/or connections between nodes). In some examples, the topology transformer 1204 uses semantic extraction to extract meaningful information about nodes and edges, such as capabilities, dependencies, and performance metrics. In some examples, the topology transformer 1204 may perform abstraction to simplify network representations so that only relevant details are included for routing decisions. The example topology transformer 1204 may identify and eliminate semantically redundant paths and nodes to improve and optimize routing efficiency. Furthermore, the example topology transformer 1204 may track network changes and update the topology representation accordingly.

In some examples, the topology transformer 1204 may be implemented using graph processing libraries like NetworkX (Python), JGraphT (Java), or neo4j for larger scale deployments. The topology transformer 1204 may maintain an internal graph representation using adjacency lists, matrices, or the like, depending on the network density. In some examples, the topology transformer 1204 may identify subnetworks based on community detection algorithms such as, for example, Louvain or Girvan-Newman. In some examples, the topology transformer 1204 may analyze paths based on variants of Dijkstra's algorithm or A* search optimized for semantic weights. In some examples, such as for static networks, the topology transformer 1204 may operate in batch mode. In some examples, such as for dynamic topologies, the topology transformer 1204 may operate in stream mode. In some such examples, the topology transformer 1204 may track changes using a version control approach similar to Git's directed acyclic graph (DAG).

In some examples, the topology transformer 1204 may use specialized graph databases for persistence. In some examples, such as for large networks, the topology transformer 1204 may implement distributed graph processing using systems like Apache Giraph or Pregel. In some examples, such as for real-time applications, the topology transformer 1204 may maintain an in-memory graph representation with periodic persistence to a backing store.

The example topology transformer 1204 may use, based on the structure and relationships between network nodes, traditional graph algorithms to collect data embedded in the individual nodes without semantically understanding the network nodes. In some examples, the topology transformer 1204 only collects data pertinent for constructing a prompt for the inference engine 1210. In some such examples, this enables the inference engine 1210 to output a focused and concise representation of the network, rather than a raw adjacency matrix, a list of nodes and edges, or some other similar full serialization.

The example prompt constructor 1206, based at least on data from the example topology transformer 1204, constructs prompts for the example inference engine 1210. In some examples, the prompt constructor 1206 implements a template-based architecture using a combination of design patterns including Builder, Strategy, and Chain of Responsibility to structure prompts consistently. The example prompt constructor 1206 may store templates in a variety of formats (YAML, JSON, or domain-specific languages) and may support inheritance and composition for complex prompt structures. In some examples, the prompt constructor 1206 may use known prompt compression techniques to reduce token usage. In some examples, the prompt constructor 1206 may employ natural language processing techniques for context integration. In some examples, the prompt constructor 1206 may use libraries like spaCy or Stanford NLP for entity recognition and relationship extraction. The example prompt constructor 1206 may incorporate historical decisions using various approaches, such as simple caching with LRU policies or sophisticated machine learning models that learn from past routing decisions. In some examples, the prompt constructor 1206 may use a rules engine (like Drools) for complex prompt construction logic. In some examples, the prompt constructor 1206 may implement a domain-specific language for defining prompt templates. In some examples, such as for high-performance scenarios, the prompt constructor 1206 may pre-compile common prompt patterns and use prototype-based cloning for rapid instantiation.

The example prompt constructor 1206 may incorporate relevant contextual information, such as network conditions and historical data. In some examples, the prompt constructor 1206 may customize prompts based on specific requirements or policies. In some examples, the prompt constructor 1206 may validate constructed prompts to ensure generated prompts meet quality and formatting requirements. In some examples, the prompt constructor 1206 may tune prompts based on historical performance data and feedback for optimization.

The example interface 1208 handles communication with inference engines, LLMs, or the like to ensure that prompts are correctly formatted. In some examples, the interface 1208 implements an adapter pattern to support multiple AI providers (OpenAI, Anthropic, local models) with a consistent interface. The example interface 1208 may be implemented as a reactive service using frameworks like Project Reactor or RxJava to handle asynchronous communication with AI providers efficiently. In some examples, the interface 1208 may validate an output to ensure it meets expected formats and standards. For example, the interface 1208 may employ a combination of schema validation (JSON Schema, Protocol Buffers) and semantic validation using predefined rules or learned patterns for response validation. In some examples, the interface 1208 may implement a multi-level caching approach by combining in-memory caches (Caffeine, Guava) with distributed caches (Redis) and persistent stores (PostgreSQL with JSONB) for different types of inference results. In some examples, the interface 1208 may implement a federated inference approach, distributing requests across multiple AI providers based on cost, performance, or specialization. In some examples, such as for latency-sensitive applications, the interface 1208 may implement predictive prefetching of common inference patterns or maintain warm connections to AI providers. The example interface 1208 may track response times, success rates, and other key metrics, and manage errors and exceptions from model interactions.

The example inference engine 1210 may be a core decision-making component that transforms structured prompts into actionable routing decisions with supported reasoning. In some examples, the inference engine 1210 is an LLM. In some examples, the inference engine 1210 may be external to the semantic routing inference engine 1200. In some examples, the inference engine 1210 may implement a multimodal approach using an ensemble of different LMMs to reduce dependency on any single model. Example 3 illustrates example code for model selection.

def select_model(self, request: RoutingRequest)->InferenceModel:
if request.is_time_critical( ):
   return self.lightweight_model #Optimized for speed
elif request.requires_complex_reasoning( ):
   return self.full_context_model #Maximum context window
else:
   return self.balanced_model #Default choice

### Example 3

In some examples, the inference engine 1210 may develop domain-specific fine-tuning pipelines to optimize model performance for specific use cases. For example, the inference engine 1210 may create domain-specific training datasets from historical routing decisions. The inference engine 1210 may implement feedback loops to capture domain expert knowledge. In some examples, the inference engine 1210 may develop specialized validation metrics for different industries. The example inference engine 1210 may build domain-specific prompt templates that encode industry best practices.

Additionally, the inference engine 1210 may perform regular evaluation and benchmarking of model performance to ensure consistent quality. In some such examples, the inference engine 1210 may implement automatic model switching based on the evaluation and benchmarking of model performance. In some examples, the inference engine 1210 may establish performance benchmarks for different operational contexts. Additionally or alternatively, the inference engine 1210 may use any other system that can perform semantic inferences and understanding of queries, requests, and calls. Likewise, the processing stages could be implemented differently, depending on the specific requirements and capabilities of the underlying inference system.

In some examples, the inference engine 1210 may perform multiple stages of processing. The inference engine 1210 may implement model-specific pre-processing as a first stage. In some examples, the inference engine 1210 may format and optimize prompts for integration with particular LLMs. For example, the inference engine 1210 may apply token-level optimizations (removing redundant tokens, compressing repetitive patterns), incorporate relevant cached responses to provide context, adjust prompt structure based on model-specific requirements, prune irrelevant context to stay within token limits, and normalize input formats for consistency. In some examples, the model-specific pre-processing may be an optional processing stage.

The inference engine 1210 may implement core processing as a second stage. In some examples, the inference engine 1210 may utilize an LLM to perform semantic reasoning. In some examples, the semantic reasoning comprises determining inferences based on predefined relationships equating concepts to particular data, logical implications of such relationships, knowledge graphs, predefined rules, and a knowledge base. In some examples, the inference engine analyzes the (preprocessed) prompt using a particular LLM. The example inference engine 1210 may consider multiple routing options or paths throughout a network (at the node level, and collectively through the entire network) and their implications. In some examples, the inference engine 1210 may evaluate trade-offs between different paths (e.g., based on the probability distributions of subsequent nodes, the objectives and/or capability of nodes, network status, network topology, node type, query context, speed, bandwidth, etc.). The inference engine 1210 may also implement traditional routing algorithms for critical paths. Based on considering the multiple routing paths, the example inference engine 1210 may output a structured path decision. In some examples, the inference engine 1210 may provide supporting reasoning for the structured path decision.

In some examples, the multiple routing options or paths considered by the inference engine 1210 may be current routing options or paths through a network that results in an output in response to a query. In some examples, the multiple routing options or paths considered by the inference engine 1210 may be hypothetical options or paths through the network based on variations of the query, variations of the network topology, etc.).

In some examples, the inference engine 1210 may implement validation as a third processing stage. The example inference engine 1210 may verify any decision meets all constraints. In some examples, the inference engine 1210 may check for logical consistency (e.g., determine whether the determined path is a valid option). In some examples, the inference engine 1210 may ensure that complete reasoning is provided. The validation by the example inference engine 1210 may serve as a sanity check to ensure the decision is valid and consistent. In some examples, the validation may be an optional processing stage.

In some examples, the aforementioned processes implemented by the inference engine 1210 may be computationally intensive, especially considering the replications of such processes across all nodes of a large scale network. To mitigate overloading, the inference engine 1210 may implement multi-level caching strategies (in-memory, distributed, and persistent), use predictive pre-computation for common routing patterns, implement request batching and priority queuing for high-traffic scenarios, deploy edge computing solutions to reduce latency in geographically distributed networks, utilize model quantization and compression techniques, implement adaptive resource allocation based on traffic patterns, and/or combine lightweight models for simple decisions and full LLMs for complex cases.

Furthermore, the inference engine 1210 may perform the following optimization techniques including, for example, prompt compression techniques to reduce token usage; model pruning, distillation, and compression for creating lightweight, domain-specific variants; quantization for reduced memory footprint; dynamic batch processing for high-volume routing scenarios; parallel processing pipelines for complex network analyses; adaptive model selection; GPU acceleration for graph processing operations; hardware-specific optimizations and memory-efficient graph representations for large-scale networks.

The example natural language transformer 1212 may determine a natural language representation of incoming data (e.g., a query). The example natural language transformer 1212 may also determine a natural language representation of the objectives and/or capabilities of a node. In some examples, the natural language transformer 1212 may output natural language representations to the prompt constructor 1206, the interface 1208, and/or the pattern matcher 1214 to determine or update probability distributions and/or generate natural language prompts.

The example pattern matcher 1214 may, based on data received from the natural language transformer 1212, compare the natural language representation of incoming data with the natural language representation of subsequent nodes to determine an initial probability distribution indicating probabilities of success in routing incoming data from one node to one or more other nodes. For example, if incoming data is indicative of a mathematical request, the pattern matcher 1214 may determine that mathematical type nodes (determined by the natural language representations of the objectives and capabilities of the node) have a higher likelihood of success in providing an accurate and quick response than other node types (e.g., linguistic type nodes). As described herein, the pattern matcher 1214 may initially determine the probability distributions of the nodes subsequent to the node which comprises the semantic routing inference engine 1200. In some examples, the pattern matcher 1214 may additionally update the probability distributions of the nodes subsequent to the node which comprises the semantic routing inference engine 1200 based on routing data (hypothetical and actual), contextual information, network topology, etc.

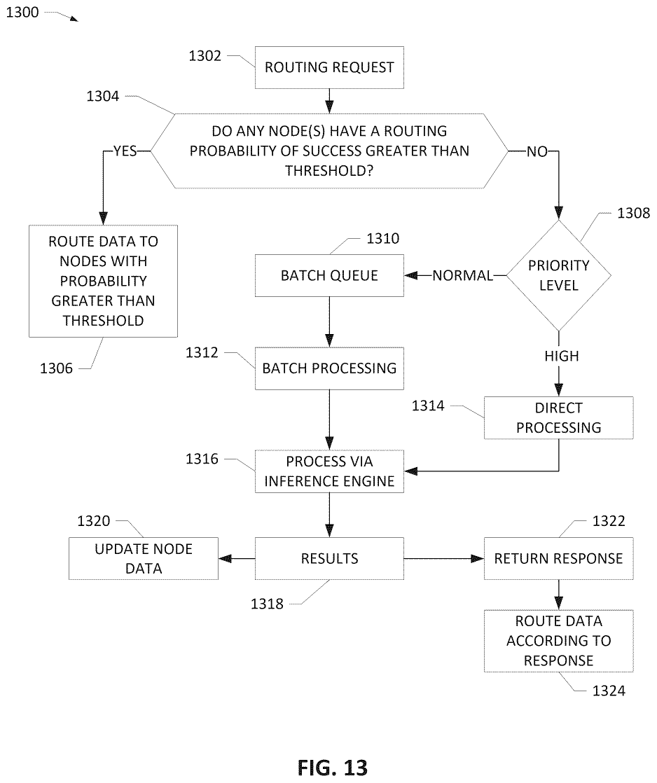

FIG. 13 illustrates an example process 1300 for optimizing routing through a network. The process 1300 may begin at step 1302 upon receipt of a routing request, which may be in the form of a query. The routing request may be received by the semantic routing inference engine 1200. At step 1304, the natural language transformer 1212 may determine a natural language representation of the request/query. The natural language transformer 1212 may also determine natural language representations of the subsequent nodes of a network. The pattern matcher 1214 may compare the natural language representation of the query to the natural language representations of the subsequent nodes of the network to determine a probability distribution identifying probabilities of success for routing the query through the network via the subsequent nodes. For example, the pattern matcher 1214, based on comparing the natural language representation of the query to the natural language representations of the subsequent nodes of the network, determine that for three subsequent nodes, the probabilities are 0.51, 0.33, and 0.16. In some examples, the probabilities of success may be based on determining whether the subsequent nodes have the capabilities to handle what is within the routing request/query (e.g., if a mathematical query comes in, then a mathematical based node may have a higher probability of success than a linguistical based node).

In some examples, the pattern matcher 1214 may further determine whether any of the probabilities of success for routing the query through the network via the subsequent nodes satisfy a threshold. In some such examples, the pattern matcher 1214 may compare the probabilities of success for routing the query through the network via the subsequent nodes to a configurable threshold, and if any of the probabilities of success for routing the query through the network via the subsequent nodes exceeds the configurable threshold then the core controller 1202 may route the query to the subsequent nodes associated with those probabilities exceeding the threshold. In the aforementioned example, the pattern matcher 1214 may set the threshold to be 0.50 and only the subsequent node associated with a probability of success of 0.51 may exceed this threshold and have data routed thereto. In other examples, multiple subsequent nodes may exceed the threshold. For example, using the same example above, if the threshold is configured to be 0.3, then the subsequent node associated with a probability of success of 0.51 and the subsequent node associated with a probability of success of 0.33 may exceed the threshold and have data routed thereto). As another example, if the threshold is set to 0, then all of the subsequent nodes may exceed the threshold and have data routed thereto.

In some examples, no subsequent nodes may satisfy the threshold. For example, the threshold may be set extremely high (e.g., 0.99) and no subsequent nodes may have a probability of success this high. Additionally or alternatively, the probabilities of success for routing the query through the network via the subsequent nodes may be too low (e.g., due to incompatibility of the nodes with the query). Alternatively, all subsequent nodes may have an equal probability of success, with none of the nodes exceeding the threshold (e.g., if the threshold is 0.51 and all subsequent nodes are associated with a probability of success of 0.50). In some such examples, the core controller 1202 may determine to prompt the inference engine 1210 for a routing determination.

Accordingly, if any of the subsequent nodes have a routing probability of success greater than the threshold (step 1304: YES), then core controller 1202 may route the incoming data (e.g., routing request/query) to those subsequent nodes at step 1306. As described herein, the core controller 1202 may determine which node to route the incoming data to next based on the probability distribution weighting the various subsequent next nodes. In some examples, the subsequent next node with the highest weighting within the probability distribution is the determined next node. In some examples, a plurality of subsequent next nodes with the highest weightings (e.g., first highest, second highest, third highest, etc.) may be the determined next nodes.

However, if none of the subsequent nodes have a routing probability of success greater than the threshold (step 1304: NO), then the core controller 1202 may determine to prompt the inference engine 1210 for a routing determination. In some examples, the core controller 1202 may determine to prompt the inference engine 1210 for a routing determination even when subsequent nodes have a routing probability of success greater than the threshold. For example, if there are a plurality of subsequent nodes that have a routing probability of success greater than the threshold, the core controller 1202 may prompt the inference engine 1210 to determine a subset of that plurality of subsequent nodes.

At step 1308, the core controller 1202 may determine a priority level associated with the incoming data. In some examples, the core controller 1202 may determine whether the priority level is high or normal/low. In some examples (such as for non-high priority queries), the inference engine 1210 may process incoming data in batch processing. In some such examples, if the core controller 1202 determines the priority level associated with the incoming data is normal (or low) priority (step 1308: NORMAL), then the core controller 1202 may queue processing of the incoming data in a batch queue (step 1310). At some time later, the core controller 1202 may prepare the incoming data in the batch queue for batch processing (step 1312). For example, the core controller 1202 may direct the prompt constructor 1206 to generate one (or more) prompt(s) to request routing decisions on all data within the batch queue at a same time (or within a threshold amount of time).

If the core controller 1202 determines the priority level associated with the incoming data is high priority (step 1308: HIGH), then the core controller 1202 may prepare the incoming data for direct processing (step 1314). For example, the core controller 1202 may direct the prompt constructor 1206 to generate a prompt to request a routing decision on just the most recent incoming data immediately (or within a threshold amount of time). At step 1316, the inference engine 1210 may process the prompts according to either step 1314 or 1312.

In examples where the inference engine 1210 is to perform batch processing, the inference engine 1210 may perform batch processing serially in the order of the queue. In some examples, the inference engine 1210 may process the data in the batch queue according to priority-based request scheduling. In some examples, the inference engine 1210 may perform batch processing of all of the data within the batch queue parallelly. In some examples, the inference engine 1210 may perform dynamic batch sizing based on load.

In examples where the inference engine 1210 is to perform direct processing, the inference engine 1210 may process the incoming data as soon as possible. In some examples, the inference engine 1210 may directly process the data prior to the data stored in the batch queue. In some examples, the inference engine 1210 may interrupt (e.g., pause) the batch processing at step 1312 to perform the direct processing at step 1314. At step 1318, the inference engine 1210 may determine the results of processing the prompt(s). At step 1320, the pattern matcher 1214 can update the probability distributions to add, increase, or decrease weights based on the results of the processing. At step 1322, the inference engine 1210 may return the results of the processing in a response to the routing request/query in a response to the core controller 1202 or to a client. At step 1324, the core controller 1202 may route the data according to the response. The example process 1300 may repeat multiple times for the same data and/or may repeat each time a node receives new incoming data.

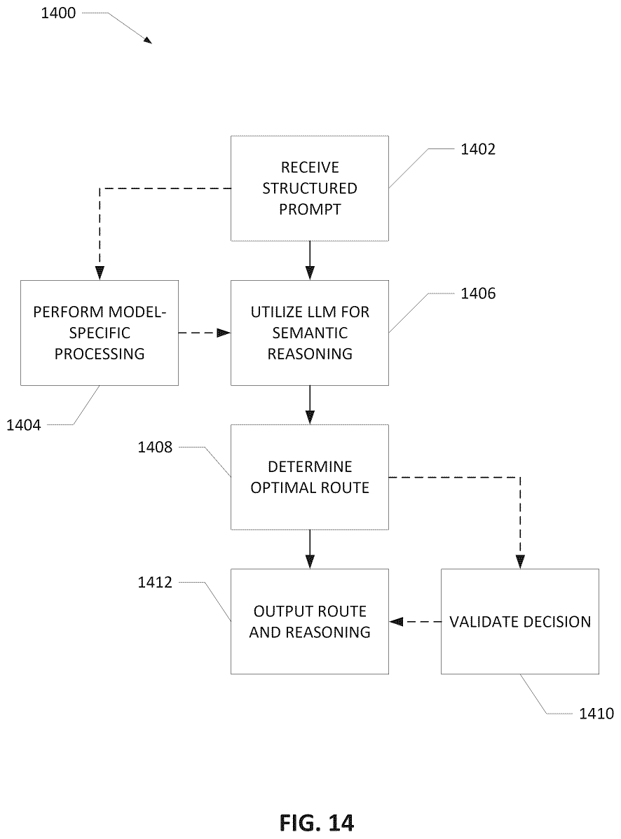

In some examples, the inference engine 1210 may perform additional processing as illustrated by process 1400 in FIG. 14. The example inference engine 1210 may receive a structured prompt at step 1402. In some examples, the structured prompt may be received from the prompt constructor 1206, which uses templates, natural language processing, libraries, patterns, prompt cloning, and/or any combination thereof to construct the prompt. In some examples, the structured prompt is a mutated prompt template. Once the prompt constructor 1206 has constructed the prompt, the prompt constructor 1206 returns the structured prompt to the core controller 1202. The core controller 1202 may forward to the structured prompt to the inference engine 1210 for execution via the interface 1208. In some examples, the prompt constructor 1206 may forward the structured prompt to the inference engine 1210 via the interface 1208 without returning the structured prompt to the core controller 1202. Based on the structured prompt, the inference engine 1210 may be able to understand the query.

At step 1404, the inference engine 1210 may optionally perform model-specific processing depending on the particular LLM being utilized. This may include applying token-level optimizations, adjusting prompt structure based on model-specific requirements and token limits, and/or normalizing input formats for consistency. At step 1406, the inference engine 1210 may utilize the LLM for semantic reasoning of the prompt and underlying query. Furthermore, at step 1408 the inference engine 1210 may determine the optimal route. This may involve, for a single node, determining the next best node based on probability distributions, the query, the type and capabilities of the node, context, network topology, etc. This may involve determining the effect of the prompt on subsequent nodes of the network. Additionally or alternatively, the inference engine 1210 may determine the optimal route based on a compilation of individual node decisions of the next best node to form the best route through the network.

In some examples, the inference engine 1210 may (optionally) validate its decision of the next best node or best route through the network at step 1410. This may involve checking that the next node or best route are valid options, reasoning is provided for each node decision, all reasoning is logical, and the decision is historically consistent. In some examples, the inference engine 1210 may implement detailed logging and audit trails for all routing decisions. The example inference engine 1210 may develop visualization tools for decision paths and reasoning processes. In some examples, the inference engine 1210 may establish confidence scoring systems for routing decisions. The example inference engine 1210 may create automated validation pipelines to verify routing decisions against predefined rules. In some examples, the inference engine 1210 may implement A/B testing frameworks to compare decisions against baseline routing strategies. The example inference engine 1210 may further develop explainable AI interfaces that break down complex decisions into understandable components. At step 1412, the inference engine 1210 may output its route decision and reasoning.

The above described routing analyses may be utilized by the optimization agent 306 for determining the impact on the network of a mutated prompt template, thereby enabling holistic impact of mutable prompt templates.

### Network Mutations

FIG. 15 illustrates an example self-adaptive layer 1500 to implement the establishment creation, adjustment, and/or removal of nodes and/or connections. The creation, adjustment, and/or removal of nodes may affect the prompt templates associated with such nodes as described herein. The example self-adaptive layer 1500 orchestrates the autonomous behavior of the network. For example, the self-adaptive layer 1500 may implement the intelligence that drives the self-adaptive capabilities. The self-adaptive layer 1500 may comprise an adaptation manager 1502, a pattern analyzer 1504, an optimization engine 1506, a mutation tester 1508, and a performance monitor 1510. The example adaptation manager 1502 may coordinate overall self-adaptive operations and strategy. In some examples, the adaptation manager 1502 may make high-level decisions about network evolution. The example adaptation manager 1502 may manage inter-component communication and orchestration. And, the adaptation manager 1502 may handle error recovery and fallback procedures.

The example pattern analyzer 1504 may analyze signal flow patterns and identify bottlenecks. In some examples, the pattern analyzer 1504 may suggest structural optimizations based on usage patterns. Furthermore, the example pattern analyzer 1504 may map data dependencies and common pathways between nodes.

The example optimization engine 1506 may generate and evaluate optimization proposals. In some examples, the optimization engine 1506 may calculate cost-benefit ratios and prioritize improvements. The optimization engine 1506 may predict performance impact of potential changes. Also, the optimization engine 1506 may maintain optimization history and success metrics.

The example mutation tester 1508 may create and validate topology mutations through A/B testing. In some examples, the mutation tester 1508 may create and analyze a plurality of mutations within a sandbox isolated from the network. In some examples, the mutation tester 1508 may create a plurality of network mutations based on the network topology and variations of context. In some examples, the mutation tester 1508 may communicate with or prompt an inference engine (local or external) to generate candidate mutations of the network. In some such examples, the inference engine may be a large language model that proposes structural variations based on the network topology and optimization goals. In some examples, multiple inference engines may compete to generate diverse mutation proposals. In some examples, the mutation tester 1508 may apply deterministic logic to generate mutations based on predefined rules. In some examples, the mutation tester 1508 may combine inference engine proposals with deterministic logic constraints to generate mutations. In some examples, the mutation tester 1508 may select one or more mutations of the plurality of mutations to analyze. For example, the mutation tester 1508 may compare mutations to one or more thresholds and select one or more mutations that satisfy the one or more thresholds (e.g., to weed out mutations with low probability of success). In some examples, the mutation tester 1508 may compare performance metrics of one (or more) network mutation(s) to performance metrics of one (or more) other network mutation(s) to select or ignore such network mutation(s) for application to the network. In some examples, the plurality of mutations may be stored for subsequent analysis by the mutation tester 1508. In some examples, the stored mutations may decay over time such that created mutations that are infrequently selected may lose relevance over time, mimicking human memory where hypothetical scenarios that are repeatedly not selected gradually fade but remain accessible for reconsideration if circumstances change. In some examples, the mutation tester 1508 ensures safe rollout with monitoring and rollback capabilities. Additionally, the mutation tester 1508 may validate mutation compatibility and stability.

The example mutation tester 1508 may implement a multi-stage evaluation process for candidate mutations. In a first stage, a large plurality of candidate mutations may be generated. For example, the mutation tester 1508 may generate from 10 to 1000 candidate mutations, such as 50, 100, 200, or 500 variants. In a second stage, these candidate mutations may be executed in sandbox environments isolated from real-world systems and live network operations, where they can be observed and analyzed without affecting operational networks. The sandbox environments may enable the mutation tester 1508 to evaluate hypothetical performance without committing resources to full deployment. Candidate mutations that produce execution errors, logical contradictions, or nonsensical outputs may be eliminated from consideration. In a third stage, remaining candidate mutations (e.g., the top 10%, 20%, or 30% of candidates based on hypothetical performance metrics) may be subjected to further refinement, combined with other surviving candidates, or advanced to real-world A/B testing. This winnowing process may mimic human deliberation where many ideas are considered mentally before committing to action, thereby enabling efficient exploration of the mutation space while avoiding costly deployment of unsuitable mutations.

Network mutations may occur at different hierarchical scales. At the finest granularity, a mutation may modify a single parameter within a node's configuration (e.g., a threshold value, a weight, or other configurable aspect of the node's operational characteristics). At intermediate scales, mutations may add, remove, or modify entire nodes or connections between nodes. At the coarsest scale, mutations may affect entire neural flows—collections of multiple interconnected nodes that function as a subsystem. The adaptation manager 1502 may determine the appropriate scale for a given optimization goal. In some examples, mutations at different scales may be generated and evaluated simultaneously, with the mutation tester 1508 comparing performance improvements across scales to select the most effective mutation regardless of its granularity.

The example performance monitor 1510 may track network metrics and identifies performance issues. In some examples, the performance monitor 1510 may trigger adaptation cycles based on configured thresholds. The example performance monitor 1510 may collect and analyze resource utilization data. And, the example performance monitor 1510 may maintain historical performance data and generate reports. In some examples, the performance monitor 1510 may analyze new networks formed based on application of network mutations. In some examples, the performance monitor 1510 may track whether or not applied mutations are successful (e.g., making the network more efficient, adding new capabilities, etc.), which may be used to provide positive or negative reinforcement of the same or similar network mutations in subsequent analyses.

In operation, the performance monitor 1510 may analyze an initial network topology. In some examples, the performance monitor 1510 receives an input image of the initial network topology. The example pattern analyzer 1504 may analyze a workflow associated with the initial network topology. For example, the pattern analyzer 1504 may identify performance bottlenecks. In some examples, the pattern analyzer 1504 utilizes the analysis of the initial network topology from the performance monitor 1510. The pattern analyzer 1504 may create a proposed new network structure based on the workflow analysis. In some examples, the proposed new network comprises optimizations of the initial network topology. The example mutation tester 1508 may analyze the proposed new network structure from the pattern analyzer 1504. In some examples, the mutation tester 1508 creates A/B testing configuration based on the analysis of the initial network topology and the analysis of the proposed new network structure. The example optimization engine 1506 may determine if the proposed new network structure is an improvement over the initial network topology. If the optimization engine 1506 determines that the proposed new network structure is an improvement over the initial network topology the adaptation manager 1502 may deploy the proposed new network structure as an optimized topology.

FIG. 16 illustrates an example adaptive computational node system 1600 in which the example self-adaptive layer 1500 may interact with one or more core layers 1602. The one or more core layers 1602 may comprise a topology layer 1604, a runtime layer 1606, and a control layer 1608. The example topology layer 1604 may maintain a declarative network structure and may provide application programming interfaces (APIs) for modifying and querying the network topology. The example runtime layer 1606 may manage the runtime execution of nodes in the network. The example control layer 1608 may manage the control flow and coordination between the runtime and topology layers, keeping track of an internal state of each signal and position in the network.

The example adaptation manager 1502 may be able to interact directly with the topology layer 1604, the runtime layer 1606, and/or the control layer 1608. In some examples, the adaptation manager 1502 may be a separate service that interacts with the one or more core layers 1602. In some such examples, the adaptation manager 1502 may interact with the one or more core layers 1602 remotely over another network, wireless network, or the Internet.

The adaptation manager 1502 may interact with the topology layer 1604 in a number of ways. In some examples, the adaptation manager 1502 (via interaction with the topology layer 1604) may request and validate topology mutations. In some examples, the adaptation manager 1502 (via interaction with the topology layer 1604) may manage topology versions and change history. In some examples, the adaptation manager 1502 (via interaction with the topology layer 1604) may coordinate topology rollout strategies.

The adaptation manager 1502 may interact with the runtime layer 1606 in a number of ways. In some examples, the adaptation manager 1502 (via interaction with the runtime layer 1606) may monitor execution metrics and performance. In some examples, the adaptation manager 1502 (via interaction with the runtime layer 1606) may manage resource allocation and scaling. In some examples, the adaptation manager 1502 (via interaction with the runtime layer 1606) may optimize node execution patterns. In some examples, the adaptation manager 1502 (via interaction with the runtime layer 1606) may control runtime configuration parameters.

The adaptation manager 1502 may interact with the control layer 1608 in a number of ways. In some examples, the adaptation manager 1502 (via interaction with the control layer 1608) may analyze signal flow patterns and bottlenecks. In some examples, the adaptation manager 1502 (via interaction with the control layer 1608) may coordinate timing of adaptation changes. In some examples, the adaptation manager 1502 (via interaction with the control layer 1608) may manage signal routing during transitions. In some examples, the adaptation manager 1502 (via interaction with the control layer 1608) may maintain signal state consistency.

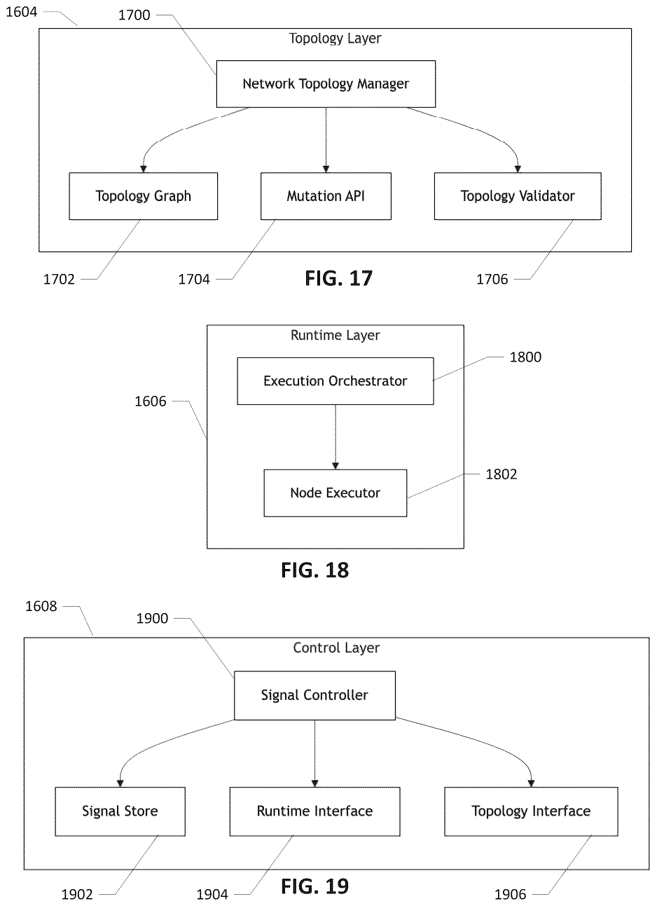

The example topology layer 1604 is illustrated in more detail in FIG. 17. The example topology layer 1604 may manage a network's structure. In some examples, the topology layer 1604 provides interfaces for topology modifications. The example topology layer 1604 may comprise a network topology manager 1700, an example topology graph 1702, an example mutation API 1704, and example topology validator 1706. The example network topology manager 1700 orchestrates all topology-related operations. The example topology graph 1702 maintains and stores the current network structure. In some examples, the topology graph 1702 comprises one or more databases. The example mutation API 1704 provides interfaces for facilitating topology modifications. In some examples, the topology modifications may comprise establishing or adding new nodes to the network, updating an existing node, removing a node from the network, ignoring a node within the network, adding a new connection between two existing nodes, updating metadata associated with an existing connection, and/or removing or ignoring a connection between two existing nodes. The example topology validator 1706 ensures the validity of any proposed changes.

The example runtime layer 1606 is illustrated in more detail in FIG. 18. The example runtime layer 1606 may handle the execution of computational nodes. In some examples, the runtime layer 1606 may perform signal processing as well. The example runtime layer 1606 may comprise an example execution orchestrator 1800 and an example node executor 1802. The example execution orchestrator 1800 coordinates the computational node execution, whereas the example node executor 1802 performs individual node processing.

The example control layer 1608 is illustrated in more detail in FIG. 19. The example control layer 1608 may coordinate between the example topology layer 1604 and runtime layer 1606. In some examples, the control layer 1608 may manage signal flow throughout the network. Example control layer 1608 may comprise a signal controller 1900, a signal store 1902, a runtime interface 1904, and a topology interface 1906. The example signal controller 1900 manages overall signal lifecycles. The example signal store 1902 stores state of all signals. In some examples, the signal store 1902 comprises one or more databases. The example runtime interface 1904 enables communication with the example runtime layer 1606. The example topology interface 1906 enables communication with the example topology layer 1604. In some examples, the topology layer 1604 and/or the runtime layer 1606 may have corresponding control layer interfaces to enable communications with the example control layer 1608.

In some examples, the topology layer 1604, the runtime layer 1606, and the control layer 1608 are separate in order to delineate individual concerns, independently scale components, simplify maintenance and updates, robustly handle errors, and efficiently utilize resources. In some examples, the topology layer 1604, the runtime layer 1606, and the control layer 1608 may be combined together.

In some examples, the network mutations described above may be equally applicable to prompt templates. In examples wherein the prompt mutator 300 is implemented at the node level, prompt templates may be created (or cloned), adjusted, and/or removed with their corresponding nodes.

### Evolutionary Arenas

As an alternative to the above described simulated or real testing, the prompt mutator 300 may subject prompt templates to one or more evolutionary arenas. FIG. 20 illustrates an example network evolution engine 2000 in accordance with the systems, methods, and apparatuses for network evolution based on arenas and genetic schema disclosed herein. The example network evolution engine 2000 may act upon any types of networks, including computational networks, and comprising any number of neurons or nodes, as well as act upon any prompt templates associated with such neurons or nodes. In some examples, the example network evolution engine 2000 may mutate one or more neurons of a network according to a genetic schema, and deploy such mutations within evolutionary arenas to face challenges and trials that test the mutations' survivability. In some examples, the mutations may be deployed within a sandbox, so as to not affect the network during arena operations. In some examples, mutations that survive the arena may be applied to the network. In some examples, applying the mutations to the network may involve changing an individual neuron's DNA.

The example network evolution engine 2000 may comprise a schema manager 2002, mutation generator 2004, an arena deployment system 2006, and a network monitor 2008. In some examples, the schema manager 2002 may establish one or more rules outlining valid mutations that can be applied to a network's configuration (e.g., a genetic schema). For example, the one or more rules may identify certain components (e.g., neurons, connections, etc.) that can (or cannot) mutate. In some examples, the one or more rules may identify certain aspects of certain components that can (or cannot) mutate. In some examples, the one or more rules may identify a level of mutation (e.g., how much a component or aspect thereof can mutate). In some examples, the one or more rules may establish a probability of mutation (e.g., a likelihood that a mutation will occur). In some examples, a parameter of a node may have a particular value range between a minimum number and a maximum number, n number of steps in a discrete increment example, specific values (e.g., value_1, value_2, . . . value_n) in a discrete value example, and a mutation probability (between 0 and 1). Example 4 illustrates an example schema in accordance with the foregoing.
gene_parameters:
   node_type:
      parameter_name:
         range: [min, max] #Valid value bounds
         step: n #Discrete increments
         mutation_rate: 0.0-1.0 #Probability of mutation
      or
         enum: [value1, value2, . . . ] #Discrete options
         mutation_rate: 0.0-1.0

### Example 4

Example 5 illustrates another example schema with exemplary numbers.
#Genetic schema identifying valid mutations
node_parameters: #components that can mutate
   conv2d:
      filters:
         Range: [32, 256] #Valid Gene Values
         step: 8 mutation_range: [8, 64] #How much this gene can mutate per generation
         mutation_rate: 0.2 #Probability of this gene mutating kernel_size:
         enum: [[3,3], [5,5], [7,7]] #Discrete gene variants
         mutation_rate: 0.1
      activation:
         enum: [relu, leaky_relu]
         mutation_rate: 0.1
   dense:
      units:
         range: [128, 1024]
         step: 32
         mutation_range: [32, 128]
         mutation_rate: 0.2
      activation:
         enum: [relu, tanh]
         mutation_rate: 0.2
      dropout_rate:
         range: [0.1, 0.5]
         mutation_range: [0.1, 0.5]
         mutation_rate: 0.15

### Example 5

In some examples, the mutation generator 2004 may generate network mutations based on the genetic schema and based on an underlying network. In some examples, the mutation generator 2004 may generate network mutations between rounds of trials set forth in an evolutionary arena. In some examples, the underlying network is an original network (e.g., a network before exposure to an evolutionary arena round). In some examples, the underlying network is an adapted network (e.g., a network updated comprising a mutation and/or adapted based on exposure to at least one evolutionary arena round). In some such examples, therefore, the mutation generator 2004 may be able to select between multiple networks (e.g., an original network and an adapted network) to use for generating network mutations in subsequent rounds of trials in the evolutionary arena.

In some examples, the mutation generator 2004 may generate mutations randomly. Such random mutation generation may enable mutations beyond human comprehension, as the human mind is not capable of comprehending the possibilities created via random mutation of each neuron and/or connection within a network. In some examples, the mutation generator 2004 may generate mutations according to a mutation rate. In some examples, the mutation rate is variable based on deterministic logic and/or feedback from network evolution monitoring as disclosed herein. In some examples, the mutation generator 2004 may generate specific mutation variants according to objectives. In some examples, the mutation generator 2004 may generate mutations as a first process and the mutations may be applied to the underlying network as a second process. In some examples, the mutation generator 2004 may generate a mutated network in a single process by cloning network neurons and applying anomalies or random variations thereto. In some examples, the mutation generator 2004 may cooperate with the network monitor 2008 to track mutation patterns.

The mutation generator 2004 may provide its generated mutations to the arena deployment system 2006. In some examples, the mutation generator 2004 may continuously generate mutations. In some examples, the mutation generator 2004 may generate mutations based on an indication from the arena deployment system 2006 that additional mutations are needed. In some examples, the mutation generator 2004 may generate mutations between rounds of the evolutionary arena. In some examples, the arena deployment system 2006 and/or the network monitor 2008 may provide indications for adjusting mutation parameters such as, for example, current variant success rates, mutation effectiveness patterns, and/or parameter-specific volatility. In some examples, the arena deployment system 2006 and/or the network monitor 2008 may indicate that mutation rate should increase where configuration similarity exceeds a threshold (e.g., greater than 90%), viable variant count drops below a minimum threshold (e.g., 5 viable variants), configuration drift stagnates (e.g., drift is below 0.001), or behavior variance is below a threshold. In some examples, the arena deployment system 2006 and/or the network monitor 2008 may indicate that mutation rate should decrease where survival rates drop significantly, multiple viable variants emerge rapidly, networks show instability patterns, or performance degrades unexpectedly.

In some examples, evolution may occur in phases. For example, in an early mutation phase (e.g., generations 1-100), it may be acceptable to have high configuration drift (0.1-0.5 per generation), many viable variants (20+), low variant similarity, and high mutation magnitude. In a mid-stage mutation phase (e.g., generations 101-1000), it may be acceptable to have moderate drift (0.01-0.05), a stable number of variants (10-15), increasing variant similarity, and targeted mutation adjustments. In a risk detection phase (e.g., generation 1001), the systems, methods, and apparatuses described herein may be on alert and looking for evolution stagnation where configuration similarity is approaching threshold (e.g., 0.89->0.90), viable variants are declining and approaching threshold (e.g., 6->5), drift rate is slowing (e.g., 0.002->0.001). In some examples, the mutation rate may be increased. In an intervention phase (e.g., generations 1002-1100), new viable variants may emerge, variant similarity may reduce, drift rate may increase, and performance maintains stability.

Examples 6-7 illustrates example network configuration mutations.
mutation_process:
   timing: between_rounds #Critical: randomness introduced during cloning, not within rounds
   mechanism: copy_with_errors
   error_introduction:
      neuron_parameters:
         temperature: 0.2 #High mutation rate for high-impact parameters
         layer_size: 0.1
         activation: 0.05
      connections:
         weight_variance: 0.15
         topology_changes: 0.2 #High mutation rate for structural changes
   validation: schema_enforcement

### Example 6

#Example mutations
mutations:
   type: modify_gene
      target: Conv2D_1
      parameters:
         filters: 96 #Mutated from 64
         kernel_size: [5,5] #New enum value selected from [3,3], [5,5], [7,7]
   type: add_gene
      location: after(MaxPool2D_1)
      gene:
         type: Conv2D
         filters: 64
         kernel_size: [3,3]
   type: adjust_gene
      target: Dense_1
      parameter: dropout_rate
      new_value: 0.3

### Example 7

In some examples, the arena deployment system 2006 may deploy mutated network variants within evolutionary arena instances. In some examples, the arena deployment system 2006 may subject a mutated network variant to one or more challenges based on arena configurations. In some examples, the arena deployment system 2006 may establish one or more survival criteria for a mutated network variant to meet for the mutated network variant to be deemed a successful variant. In some examples, the one or more survival criteria may be different from the one or more challenges. In some examples, an evolutionary arena instance may comprise multiple rounds, with each round having a timed lifespan (e.g., 24 hours) during which network variants operate and are evaluated. During a round, a network variant may adapt and evolve through reasoning and learning mechanisms, but such adaptations may be deterministic responses to environmental challenges rather than random mutations. In some examples, the arena deployment system 2006 may cooperate with the network monitor 2008 to determine if a mutated network variant meets or fails to meet the survival criteria during a round. In some examples, the arena deployment system 2006 may set up numerous trials within a single round. If a mutated network variant fails to meet a survival criteria in any trial, the arena deployment system 2006 may terminate that round. If a mutated network variant meets a survival criteria threshold for a given trial, the arena deployment system 2006 may count that trial as successful. In some examples, the arena deployment system 2006 may compare a successful trial count associated with a mutated network variant against a threshold or other successful trial counts associated with other mutated network variants to determine which variant should become the next base network (e.g., the variant with the highest successful trial count, one or more variants with successful trial counts exceeding a threshold, etc.). In some such examples, the comparison may occur between rounds of the evolutionary arena instance. In some examples, the comparison may occur after all rounds of the evolutionary arena instance.

Examples 8-9 illustrates example survival criteria and challenges. While certain numbers, sources, challenge types, and threshold values are shown in Example 6 for exemplary purposes, the numbers may be any number n, the sources may be any data source, the challenge types may be any specific task domain, and the threshold values may be any value and may be configured as minimum or maximum thresholds as shown in Example 8.
challenge_type: [specific task domain]
challenge_parameters:
   dataset: [data source]
   batch_size: n
   evaluation_steps: n
   round_duration: [timespan]
survival_criteria:
   metric_1: >=threshold
   metric_2: <=threshold
   metric_3: <=threshold

### Example 8

#Arena survival criteria and challenges
challenge_type: image_classification
challenge_parameters:
   dataset: cifar10
   batch_size: 32
   evaluation_steps: 1000
   round_duration: 24 hr
survival_criteria:
   accuracy: >=0.92
   inference_time: <=15 ms
   memory_usage: <=750 MB

### Example 9

The example network monitor 2008 may maintain effective evolutionary pressure by implementing sophisticated monitoring and control mechanisms. In some examples, metrics such as accuracy or survival rate may not capture loss of evolutionary diversity, such that a network may become stagnant despite having high performance (e.g., because new solutions may not be explored). In some such examples, only minor variations may survive, structural mutations may become ineffective, variants may cluster around narrow behaviors, and evolutionary potential may diminish while performance metrics remain stable. Thus, in some examples, the network monitor 2008 may track and manage evolutionary progress to prevent stagnation and ensure continued adaptation. In some examples, the network monitor 2008 may monitor genetic drift from origin, variant diversity metrics, success of different mutation patterns, variant success rates, mutation effectiveness patterns, and/or parameter-specific volatility. Example 10 illustrates an example measurement of network configuration drift. While certain numbers are shown in Example 10 for exemplary purposes, the numbers may be any number n or value.
configuration_drift:
   absolute_drift:
      from_origin: 0.015 #Distance from original configuration
      rolling_window: 100 #Compare against recent history
   historical_trend:
      generation: 13
         drift: 0.012
      generation: 14
         drift: 0.014

### Example 10

Example 11 illustrates an example analysis of variant diversity. While certain numbers are shown in Example 11 for exemplary purposes, the numbers may be any number n or value (with the similarity and variance parameters being between 0 and 1).
diversity_metrics:
   configuration_similarity: 0.85 #% similarity to base network
   viable_variants: 12 #Successful mutations count
   behavioral_variance: 0.34 #Functional diversity measure

### Example 11

Example 12 illustrates an example analysis of mutation frequency, success, impact, and volatility. While certain numbers are shown in Example 12 for exemplary purposes, the numbers may be any number n or value (with the frequency, impact, and volatility scores being between 0 and 1).
gene_evolution:
   parameter_name:
      mutation_frequency: 0.25
      successful_mutations: 45
      average_impact: 0.12
      volatility_score: 0.78 #Higher for temperature parameters

### Example 12

Example 13 illustrates an exemplary analysis of gene mutations and rates, ranges, and volatility thereof. While certain numbers are shown in Example 13 for exemplary purposes, the numbers may be any number n or value (with the rates and volatility weights being between 0 and 1).
mutation_parameters:
   genes_per_mutation: [1, 5]
   gene_mutation_rates:
      temperature_parameter:
         valid_range: [0.0, 2.0] mutation_rate: 0.3 #High mutation rate for high-impact parameters
         volatility_weight: 0.9 #High impact=higher weight
      layer_size:
         valid_range: [32, 256]
         mutation_rate: 0.1 #Lower rate for structural parameters
         volatility_weight: 0.4

### Example 13

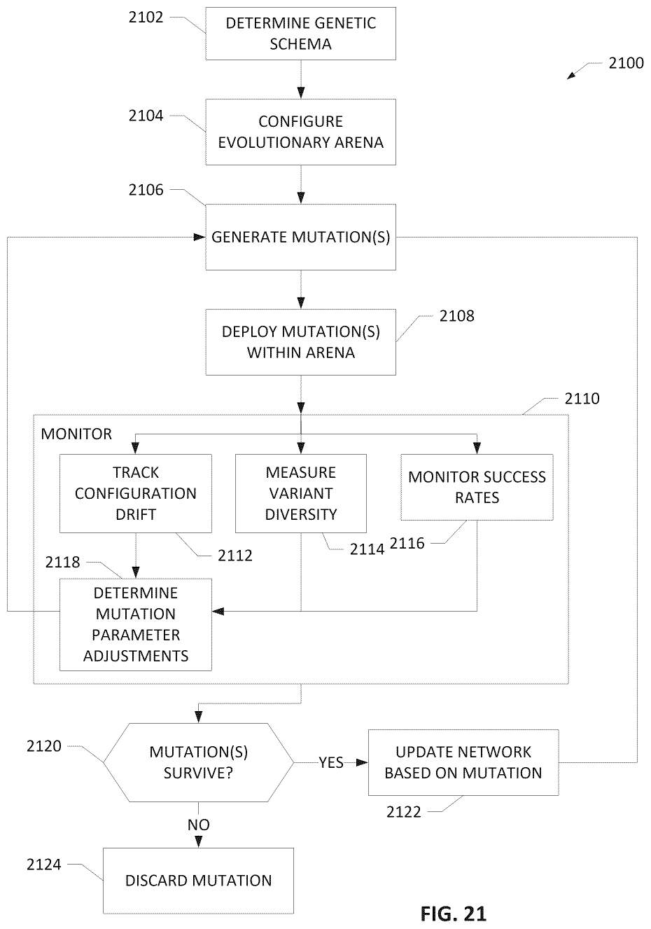

In operation, the example network evolution engine 2000 may generate network mutations based on neurons of a network, test the generated network mutations across number rounds of challenges and measured against survival criteria, determine successful (and unsuccessful) mutations, apply successful mutations to the network to generate an evolved network, and continuously evolve the network by repeating this process. For example, the network evolution engine 2000 may implement an example network evolution process 2100 as shown in FIG. 21. In some examples, the network evolution process 2100 may be applied to valid computational networks.

The network evolution process 2100 may begin at step 2102, where the schema manager 2002 may determine a genetic schema for a network as described above. At step 2104, the arena deployment system 2006 may configure an evolutionary arena based on a configuration of arena parameters. At step 2106, the mutation generator 2004 may generate one or more mutations based on the network. At step 2108, the arena deployment system 2006 may deploy the one or more mutations within the one or more instances of the evolutionary arenas for a timed round (e.g., 20 minutes, 1 hour, 12 hours, a day, 3 days, a week, etc.) with particular survival criteria. In some examples, the arena deployment system 2006 may deploy the one or more mutations in a single evolutionary arena instance with common challenges and survival criteria so that the mutations may compete with each other in a survival of the fittest scenario. In some examples, the arena deployment system 2006 may deploy the one or more mutations within individual evolutionary arena instances with varying challenges and survival criteria for diverse mutations. In some examples, the arena deployment system 2006 may deploy the one or more mutations in a hybrid approach, with some evolutionary arena instances having a single mutation therein while other evolutionary arena instances have multiple mutations therein. In some examples, the arena deployment system 2006 may conduct multiple trials or rounds with one or more mutations within one or more evolutionary arena instances.

At step 2110, the network monitor 2008 may monitor the one or more mutations within the one or more evolutionary arena instances for the timed duration. The network monitor 2008 may track configuration drift from the base network at step 2112. The network monitor 2008 may measure variant diversity, including the magnitude of mutations and gene-specific mutation effectiveness, at step 2114. The network monitor 2008 may monitor success or survival rates at step 2116. At step 2118, the network monitor 2008 may determine mutation parameter adjustments based on the tracked configuration drift, the measured variant diversity, and/or the monitored success rates from steps 2112, 2114, and 2116 respectively. In some examples, the network monitor 2008 may send the determined mutation parameter adjustments to the mutation generator 2004 for the generation of additional mutation(s) during the next round.

In some examples, the network monitor 2008 and/or the arena deployment system 2006 may determine, based on the monitored metrics (such as, for example, survival criteria), whether one or more mutations survive that round of the arena instance(s) (step 2120). In some examples, the network mutation may have to meet all survival criteria to survive. In some such examples, if a network mutation fails any criterion, that round may be deemed a failure. If the network monitor 2008 and/or the arena deployment system 2006 determines that one or more mutations survive the round (step 2120: YES), the network monitor 2008 and/or the arena deployment system 2006 may update the network based on the one or more mutations (step 2122). In some examples, the ability to clone adapted networks enables a form of inheritance of acquired characteristics, where successful learned behaviors discovered during a network's operational lifespan can be passed to the next generation, thereby accelerating evolutionary progress beyond what random mutation alone could achieve. In some examples, this differs fundamentally from biological evolution, where only genetic material is inherited and learned behaviors cannot be directly transmitted to offspring.

In some examples, the network monitor 2008 and/or the arena deployment system 2006 may update the network based on all surviving mutations. In some examples, the network monitor 2008 and/or the arena deployment system 2006 may count a number of successful trials that a mutation survives. In some examples, the network monitor 2008 and/or the arena deployment system 2006 may update the network based on any surviving mutations that have a successful trial count over a threshold. In some examples, the network monitor 2008 and/or the arena deployment system 2006 may update the network based on the mutation having the highest successful trial count. Thereafter, the mutation generator 2004 may generate additional mutations at step 2106 based on the updated network and/or the mutation parameter adjustments determined at step 2118 for the next round. If the network monitor 2008 and/or the arena deployment system 2006 determines that a mutation does not survive the arena (step 2120: NO), the mutation may be discarded or destroyed (step 2124). The network evolution process 2100 may be repeated continuously across generations. Examples 14-15 illustrates an example rounds and generational structures.
Evolutionary Arena Structure
   Round 1 (e.g., 24 hours)
Network variant operates
Multiple trials executed (e.g., 100 trials)
Each trial: success or failure against survival criteria
Survival rate calculated: successes/total trials
Cloning Phase (between Round 1 and Round 2)
Select survivors based on survival rates
Choose base version (original or adapted)
Clone network neuron-by-neuron
Inject random mutations during cloning per genetic schema
Validate mutations
Round 2 (24 hours)
New mutated variants operate
Multiple trials executed
Survival assessed
Cloning Phase (between Round 2 and Round 3)
Select survivors
Clone with mutations
Continues across generations . . .

### Example 14

Generation 1: Deploy→Round 1→Survival Check→Clone survivors with mutations
Generation 2: Deploy→Round 2→Survival Check→Clone survivors with mutations
Generation 3: Deploy→Round 3→Survival Check→Clone survivors with mutations
. . . continues indefinitely

### Example 15

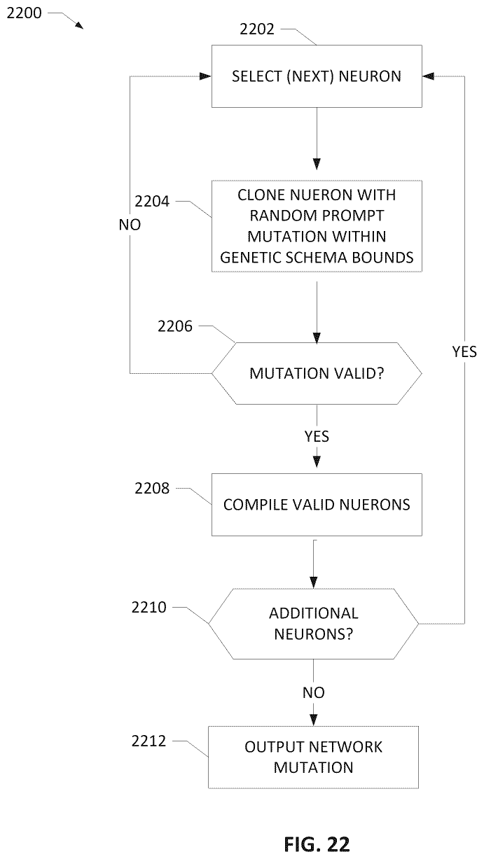

FIG. 22 illustrates an example mutation process 2200. In some examples, mutation process 2200 may be applied to an original network (a network before a round within the evolutionary arena) or an adapted network (e.g., a network after a round within the evolutionary arena with any mutations and any adaptions that were necessary to survive). In some examples, the mutation generator 2004 may select between the original and adapted network to determine whether to pass down mutated or learned characteristics during network cloning. For example, the mutation generator 2004 may determine to pass down acquired characteristics rather than just genetic traits. In some examples, the mutation generator 2004 may be preconfigured to always clone the original network. In some examples, the mutation generator 2004 may be preconfigured to always clone the adapted network. In some examples, the mutation generator 2004 may statistically determine to clone either the original or adapted network. For example, the mutation generator 2004 may evaluate metrics monitored by the network monitor 2008 to determine which network will produce better evolutionary outcomes in the near term (e.g., the next round). In some examples, the mutation generator 2004 may utilize generational data to determine whether the original or adapted network may produce better evolutionary outcomes over many generations.

In some examples, different arena configurations may factor into which network (original or adapted) the mutation generator 2004 may use to generate mutations for the next round. In some examples, the mutation generator 2004 may determine optimal strategy through meta-analysis of evolutionary progress by tracking statistical outcomes across multiple generations (e.g., hundreds or thousands of rounds) to identify whether cloning from original networks or adapted networks produces superior evolutionary outcomes in terms of stability, diversity maintenance, performance trends, and long-term adaptation capabilities. In some examples, this meta-evolutionary optimization may be performed automatically without human intervention.

In some examples, the mutation process 2200 may begin at step 2202, where the mutation generator 2004 may select a neuron or a connection from the (original or adapted) network. At the beginning of the mutation process 2200, the mutation generator 2004 may select a first neuron. At step 2204, the mutation generator 2004 may clone or otherwise copy the selected neuron or connection, and introduce a random mutation, anomaly, or variation to the copied selected neuron or connection. In some examples, the introduced random mutation may be within the bounds of the genetic schema (e.g., according to a mutation rate, within a set number of neuron mutations, etc.). In some examples, high-volatility genes (e.g., temperature parameters) may mutate more frequently. Example 16 illustrates an example cloning configuration.
cloning_configuration:
   source_version: [original|adapted]
   selection_criteria: [statistical|preconfigured]
   mutation_settings:
      mutation_rate: 0.0-1.0
      affected_parameters: [parameter_list]
         schema_constraints: [validation_rules]

### Example 16

At step 2206, the mutation generator 2004 may validate the mutation to ensure that the mutation meets the genetic schema and would result in an operational network. If the mutation is not valid (step 2206: NO), the mutation may be discarded (e.g., the neuron or connection is cloned without a mutation) and the mutation process 2200 may return to step 2202 to select the next neuron or connection. If the mutation is valid (step 2206: YES), the mutation generator 2004 may compile together the valid neurons and connections (step 2208). The mutation generator 2004 may then check if there are any additional neurons or connections left in the network (step 2210). In some examples, the mutation generator 2004 may determine if there are any additional neurons or connection if a neuron or connection limit in the genetic schema has not been met. If the mutation generator 2004 determines that there are additional neurons or connections left in the network (step 2210: YES), the mutation process 2200 may return to step 2202 to select the next neuron or connection. If the mutation generator 2004 determines that there are no additional neurons or connections left in the network (step 2210: NO), the mutation generator 2004 may output a new network with one or more nodes and/or connections mutated according to step 2204 (step 2212). Example 17 illustrates an example mutated network.
#Example mutations
mutations:
   type: modify_gene
      target: Conv2D_1
      parameters:
      filters: 96 #Mutated from 64
      kernel_size: [5,5] #New enum value selected from [3,3], [5,5], [7,7]
   type: add_gene
      location: after(MaxPool2D_1)
gene:
   type: Conv2D
      filters: 64
      kernel_size: [3,3]
   type: adjust_gene
      target: Dense_1
      parameter: dropout_rate
      new_value: 0.3

### Example 17

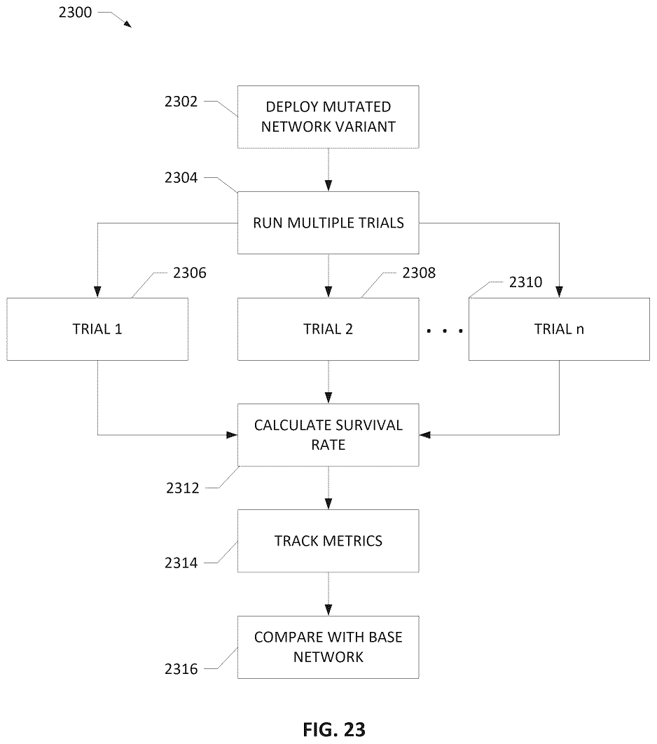

FIG. 23 illustrates an example mutation variant trial process 2300. In some examples, the mutation variant trial process 2300 may implement steps 2108-2110 described above with reference to FIG. 21. The mutation variant trial process 2300 may begin at step 2302 with the arena deployment system 2006 deploying one or more mutated network variants within one or more evolutionary arena instances. At step 2304, the arena deployment system 2006 may configure multiple trials for which the mutations network variants may be subjected during a single round duration. In some examples, the arena deployment system 2006 may run any number of trials including a first trial 2306, a second trial 2308, and up to an n trial 2310. In some examples, these trials may be run in parallel. In some such examples, the network monitor 2008 and/or the arena deployment system 2006 may calculate the survival rate of the mutated network variant across all trials (step 2312). In some examples, these trials may run in series. In some such examples, the network monitor 2008 and/or the arena deployment system 2006 may calculate the survival rate after each trial. In some example, the network monitor 2008 may track metrics associated with the trials (step 2314). At step 2316, the network monitor 2008 and/or the arena deployment system 2006 may compare surviving mutated network variants (and their metrics) with the base network (and its metrics). Example 18 illustrates exemplary metrics tracked at step 2314, which may be used in the comparison at step 2316.
deployment_metrics:
   variant_id: mutation_284
   trials_completed: 100
   trial_results:
      successes: 20
      failures: 80
      survival_rate: 0.20 #Target rate for optimal evolution pressure
fitness_trend:
   current_rate: 0.20
   previous_rates:
      generation: 1
         rate: 0.12
      generation: 2
         rate: 0.15
      generation: 3
         rate: 0.20
   delta: +0.05 #Rate of improvement
   trend: increasing #Key indicator of evolution success
status: evolution_progressing

### Example 18

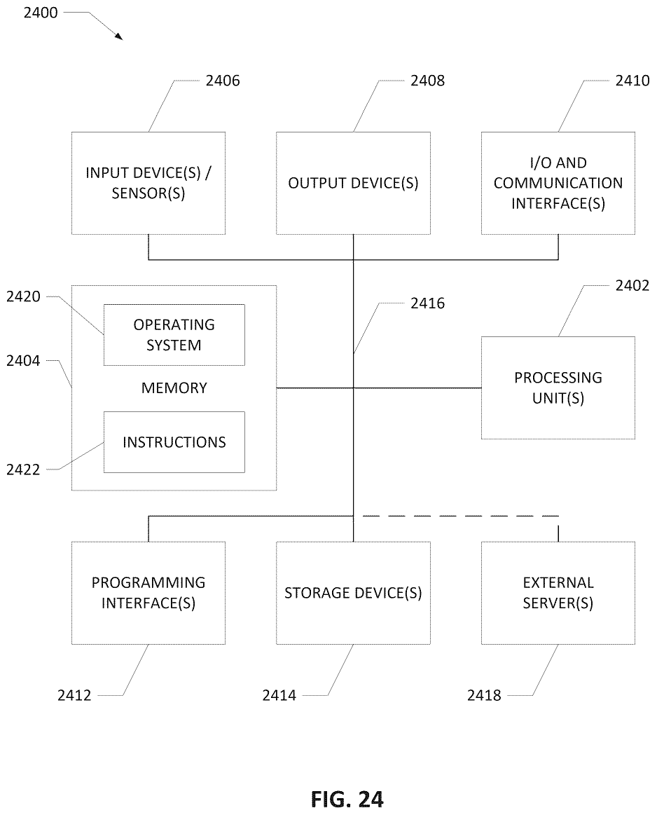

FIG. 24 illustrates an example computing device 2400 that may be used in accordance with the teachings described herein. The example computing device 2400 may be a computer, a tablet, a mobile device, a server, a workstation, an internet-of-things (IoT) device, a smart appliance, a network node, a hub, a router, a modem, or the like. The example computing device 2400 may comprise one or more processing units 2402, one or more memory 2404, one or more input devices or sensors 2406, one or more output devices 2408, one or more input/output (I/O) and communication interfaces 2410, one or more programming interfaces 2412, and one or more storage devices 2414. Each of the one or more processing units 2402, one or more memory 2404, one or more input devices or sensors 2406, one or more output devices 2408, one or more input/output (I/O) and communication interfaces 2410, one or more programming interfaces 2412, and one or more storage devices 2414 may be interconnected via wired connections such as, for example, a bus 2416. Alternatively, each of the one or more processing units 2402, one or more memory 2404, one or more input devices or sensors 2406, one or more output devices 2408, one or more input/output (I/O) and communication interfaces 2410, one or more programming interfaces 2412, and one or more storage devices 2414 may be interconnected wirelessly. In some examples, each of the one or more processing units 2402, one or more memory 2404, one or more input devices or sensors 2406, one or more output devices 2408, one or more input/output (I/O) and communication interfaces 2410, one or more programming interfaces 2412, and one or more storage devices 2414 may be interconnected via a combination of wired and wireless connections. In some examples, the example computing device 2400 may be connected to one or more external servers 2418.

In some examples, the processing unit 2402 may be a processor such as a central processing unit (CPU), a microprocessor, integrated circuit (IC), an application-specific integrated circuit (ASIC), a Field Programmable Gate Array (FPGA), or a graphical processing unit (GPU). In some examples, the computing device 2400 may have one or more processing units 2402 for parallel processing. In some such examples, the one or more processing units 2402 may be of the same type (e.g., multiple microprocessors). In some examples, the one or more processing units 2402 may be of different types (e.g., at least one CPU and at least one GPU).

In some examples, the memory 2404 may be a non-transitory computer readable storage medium. In some examples, the memory 2404 may include random-access memory, such as DRAM, SRAM, DDR RAM, or other random-access solid-state memory devices. In some examples, the memory 2404 may include an operating system 2420 and instructions 2422.

The operating system 2420 may be a traditional operating system that relies on pre-defined rules and structures such as, for example, Microsoft Windows®, Linux, macOS, etc. The operating system 2420 may be able to function effectively on a wide range of devices and platforms including smartphones, tablets, desktops, servers, etc. In some examples, the operating system 2420 may be decentralized, such that users may share resources and may collaborate without reliance on centralized servers.

The instructions 2422 may comprise computer executable instruction sets for implementing the exemplary processes 400, 1100, 1300, 1400, 2100, 2200, and 2300 in FIGS. 4, 11, 13-14, and 21-23.

In some examples, the one or more input devices or sensors 2406 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 2408 may comprise one or more displays, one or more speakers, one or more lights (e.g., light emitting diodes), a signal generator, a haptics engine, a printer, or the like.

In some examples, the one or more I/O and communication interfaces 2410 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, I2C, or a similar type of interface.

In some examples, the one or more programming interfaces 2412 may comprise software for implementing one or more physical I/O and communication interfaces, APIs configured for communication with and providing services to databases, software applications, the Internet, or the like.

In some examples, the one or more storage devices 2414 may comprise non-volatile memory, such as one or more magnetic disk storage devices, optical disk storage devices, flash memory devices, or other non-volatile solid-state storage devices. In some examples, the one or more storage devices 2414 may include one or more databases.

In some examples, the one or more external servers 2418 may comprise external processing and storage that may be utilized by the example computing device 2400. In some examples, the one or more external servers 2418 may be configured similarly to the example computing device 2400.

One or more example apparatus, systems, and computer-readable storage mediums are described below. An example apparatus may comprise one or more processors and memory storing instructions that, when executed by the one or more processors, cause creating, based on a received instruction, context, and template, a prompt template, providing one or more neurons of a network with the prompt template, testing the prompt template across the one or more neurons, based on first environmental feedback from testing the prompt template and based on predefined behavior of the one or more neurons, determining one or more prompt template mutations, testing the one or more prompt template mutations across the one or more neurons, and repeating 1) the determining the one or more prompt template mutations and 2) testing the one or more prompt template mutations, until second environmental feedback from testing the one or more prompt template mutations fails to exceed a threshold.

Some apparatuses may further comprise instructions to query a large-language model for improved versions of the prompt template.

Some apparatuses may further comprise instructions to validate the one or more prompt template mutations.

In some apparatuses, the second environmental feedback is negative feedback and the threshold is a negative feedback threshold.

In some apparatuses, the predefined behavior of the one or more neurons varies from neuron to neuron, such that different prompt template mutations are determined for each neuron.

In some apparatuses, at least one of the testing the prompt template across the one or more neurons or the testing the one or more prompt template mutations across the one or more neurons occurs within one or more evolutionary arenas.

In some apparatuses, the environmental feedback is based on a real or simulated environment.

An example method may comprising the steps of creating, based on a received instruction, context, and template, a prompt template, providing one or more neurons of a network with the prompt template, testing the prompt template across the one or more neurons, based on environmental feedback from testing the prompt template and based on predefined behavior of the one or more neurons, determining one or more prompt template mutations, testing the one or more prompt template mutations across the one or more neurons, and repeating the determining the one or more prompt template mutations and the testing the one or more prompt template mutations steps until environmental feedback from testing the one or more prompt template mutations fails to exceed a threshold.

Some methods further comprise querying a large-language model for improved versions of the prompt template.

Some methods further comprise validating the one or more prompt template mutations.

In some methods, the second environmental feedback is negative feedback and the threshold is a negative feedback threshold.

In some methods, the predefined behavior of the one or more neurons varies from neuron to neuron, such that different prompt template mutations are determined for each neuron.

In some methods, at least one of the testing the prompt template across the one or more neurons or the testing the one or more prompt template mutations across the one or more neurons occurs within one or more evolutionary arenas.

In some methods, the environmental feedback is based on a real or simulated environment.

An example computer readable storage medium may store instructions that, when executed, cause performance of any of the above methods.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
one or more processors; and
memory storing instructions that, when executed by the one or more processors, cause:
creating, based on a received instruction, context, and template, a prompt template;
providing one or more neurons of a network with the prompt template;
testing the prompt template across the one or more neurons;
based on first environmental feedback from testing the prompt template and based on predetermined behavior of the one or more neurons, determining one or more prompt template mutations;
testing the one or more prompt template mutations across the one or more neurons; and
repeating 1) the determining the one or more prompt template mutations and 2) the testing the one or more prompt template mutations, until second environmental feedback from testing the one or more prompt template mutations fails to exceed a threshold.

2. The apparatus of claim 1, wherein the instructions, when executed by the one or more processors, cause determining the one or more prompt template mutations by:
querying a large-language model for improved versions of the prompt template.

3. The apparatus of claim 1, wherein the instructions, when executed by the one or more processors, cause validating the one or more prompt template mutations.

4. The apparatus of claim 1, wherein the second environmental feedback is negative feedback and wherein the threshold is a negative feedback threshold.

5. The apparatus of claim 1, wherein the predetermined behavior of the one or more neurons varies from neuron to neuron, such that different prompt template mutations are determined for each neuron.

6. The apparatus of claim 1, wherein at least one of the testing the prompt template across the one or more neurons or the testing the one or more prompt template mutations across the one or more neurons occurs within one or more evolutionary arenas.

7. The apparatus of claim 1, wherein the environmental feedback is based on a real or simulated environment.

8. The apparatus of claim 1, wherein at least one neuron of the one or more neurons comprises a mutation rate ranging from zero to a maximum value, wherein the mutation rate determines a propensity for the at least one neuron to generate prompt template mutations based on environmental feedback.

9. The apparatus of claim 8, wherein the mutation rate for the at least one neuron is zero, and wherein the instructions, when executed by the one or more processors, cause refraining from generating prompt template mutations for the at least one neuron regardless of environmental feedback received.

10. The apparatus of claim 1, further comprising:
ceasing the determining of the one or more prompt template mutations when the first environmental feedback or the second environmental feedback comprises positive feedback that indicates satisfactory performance; and
determining the one or more prompt template mutations when either the first environmental feedback or the second environment comprises negative feedback that indicates unsatisfactory performance.

11. The apparatus of claim 1, wherein at least one neuron of the one or more neurons comprises:
a static layer comprising the predetermined behavior, wherein the predetermined behavior determines a role and transformation behavior of the at least one neuron; and
a dynamic layer comprising the prompt template that operates within constraints established by the static layer, wherein the one or more prompt template mutations modify the dynamic layer while preserving the static layer.

12. The apparatus of claim 1, wherein determining the one or more prompt template mutations comprises selecting, from a plurality of candidate mutations, a mutation that produces a least amount of negative environmental feedback.

13. The apparatus of claim 1, wherein the first environmental feedback comprises network-wide performance metrics indicating effects of the prompt template across multiple interconnected neurons, and wherein the one or more prompt template mutations are determined based on improving network-wide performance.

14. A method comprising:
creating, based on a received instruction, context, and template, a prompt template;
providing one or more neurons of a network with the prompt template;
testing the prompt template across the one or more neurons;
based on first environmental feedback from testing the prompt template and based on predetermined behavior of the one or more neurons, determining one or more prompt template mutations;
testing the one or more prompt template mutations across the one or more neurons; and
repeating the determining the one or more prompt template mutations and the testing the one or more prompt template mutations steps until second environmental feedback from testing the one or more prompt template mutations fails to exceed a threshold.

15. The method of claim 14, further comprising querying a large-language model for improved versions of the prompt template.

16. The method of claim 14, further comprising validating the one or more prompt template mutations.

17. The method of claim 14, wherein the second environmental feedback is negative feedback and wherein the threshold is a negative feedback threshold.

18. The method of claim 14, wherein the predetermined behavior of the one or more neurons varies from neuron to neuron, such that different prompt template mutations are determined for each neuron.

19. The method of claim 14, wherein at least one of the testing the prompt template across the one or more neurons or the testing the one or more prompt template mutations across the one or more neurons occurs within one or more evolutionary arenas.

20. The method of claim 14, wherein the environmental feedback is based on a real or simulated environment.

21. A computer readable storage medium storing instructions that, when executed, cause:
creating, based on a received instruction, context, and template, a prompt template;
providing one or more neurons of a network with the prompt template;
testing the prompt template across the one or more neurons;
based on first environmental feedback from testing the prompt template and based on predetermined behavior of the one or more neurons, determining one or more prompt template mutations;
testing the one or more prompt template mutations across the one or more neurons; and
repeating the determining the one or more prompt template mutations and the testing the one or more prompt template mutations steps until second environmental feedback from testing the one or more prompt template mutations fails to exceed a threshold.

22. The storage medium of claim 21, wherein the instructions, when executed, further cause querying a large-language model for improved versions of the prompt template.

23. The storage medium of claim 21, wherein the instructions, when executed, further cause validating the one or more prompt template mutations.

24. The storage medium of claim 21, wherein the second environmental feedback is negative feedback and wherein the threshold is a negative feedback threshold.

25. The storage medium of claim 21, wherein the predetermined behavior of the one or more neurons varies from neuron to neuron, such that different prompt template mutations are determined for each neuron.

26. The storage medium of claim 21, wherein at least one of the testing the prompt template across the one or more neurons or the testing the one or more prompt template mutations across the one or more neurons occurs within one or more evolutionary arenas, real environments, or simulated environments.
